(19) United States
(12) Patent Application Publication
(10) Pub. No.: US 2025/0043035 A1
(43) Pub. Date: Feb. 6, 2025

(54) METHOD TO IMPROVE THE OPTICAL PROPERTIES OF ETHYLENE COPOLYMER COMPOSITIONS

(71) Applicant: NOVA CHEMICALS (INTERNATIONAL) S.A., Fribourg (CH)

(72) Inventors: Vinod Konaganti, Calgary (CA); Sepideh Kasiri, Calgary (CA)

(73) Assignee: NOVA CHEMICALS (INTERNATIONAL) S.A., Fribourg (CH)

(21) Appl. No.: 18/722,740

(22) PCT Filed: Jan. 13, 2023
(86) PCT No.: PCT/IB2023/050321

§ 371 Date: Jun. 21, 2024

Related U.S. Application Data
(60) Provisional application No. 63/301,445, filed on Jan. 20, 2022.

(51) Int. Cl. C08F 2/01; C08F 2/00; C08F 2/06; C08F 4/659; C08F 210/16; C08J 5/18

(52) U.S. Cl. CPC C08F 2/01; C08F 2/001; C08F 2/06; C08F 4/65912; C08F 210/16; C08J 5/18; C08F 2400/02; C08F 2420/04; C08J 2323/08

(57) ABSTRACT

The present disclosure provides a method to improve the optical properties of an ethylene copolymer composition which is made in a multi reactor solution phase polymerization process. A single site catalyst is employed in a first polymerization reactor and a multi-site catalyst is employed in a second polymerization reactor arranged in series with the first polymerization reactor. The method involves increasing the amount of alpha olefin fed to a second polymerization reactor relative to the amount of alpha olefin fed to a first polymerization reactor, and if desired, optimizing other process conditions across the two reactors, such as the overall alpha-olefin to ethylene ratio, the polymerization temperature of the reactors, and the amount of hydrogen fed to each reactor, in order to maintain the density and the melt index of the ethylene copolymer composition.

### TECHNICAL FIELD

The present disclosure provides a method to improve the optical properties of an ethylene copolymer composition which is made in a multi reactor solution phase polymerization process. The method involves increasing the amount of alpha olefin fed to a second polymerization reactor relative to the amount of alpha olefin fed to a first polymerization reactor, where the reactors are configured in series with one another.

### BACKGROUND ART

Multicomponent polyethylene compositions are well known in the art. One of the methods used to access multicomponent polyethylene compositions is to use two or more distinct polymerization catalysts in one or more polymerization reactors. For example, the use of single site and Ziegler-Natta type polymerization catalysts in at least two distinct solution polymerization reactors configured in series with one another is known.

Solution polymerization processes are generally carried out at temperatures above the melting point of the ethylene copolymer composition being made. In a typical solution polymerization process, catalyst components, solvent, monomers and hydrogen are fed under pressure to one or more reactors.

For solution phase ethylene copolymerization processes, the reactor temperatures can range from about 80° C. to about 300° C. while pressures generally range from about 3 MPag to about 45 MPag. The ethylene copolymer composition produced remains dissolved in the solvent under reactor conditions. The residence time of the solvent in the reactor may be relatively short, for example, from seconds up to about 20 minutes. The solution process can be operated under a wide range of process conditions that allow the production of a wide variety of ethylene copolymer compositions. Post reactor, the polymerization reaction is quenched to prevent further polymerization, by adding a catalyst deactivator, and optionally passivated, by adding an acid scavenger. Once deactivated (and optionally passivated), the polymer solution is passed to a polymer recovery operation (a devolatilization system) where the ethylene copolymer composition is separated from process solvent, unreacted residual ethylene and unreacted optional α-olefin(s).

Regardless of the manner of production, there remains a need to improve the performance of multicomponent ethylene copolymer compositions. For example, methods which improve the optical performance of ethylene copolymer compositions in film applications would be desirable.

### SUMMARY OF INVENTION

Provided is a method for improving the optical properties of an ethylene copolymer composition made in a solution phase polymerization process;
the solution phase polymerization process comprising:
   polymerizing ethylene and an alpha-olefin in a first reactor with a single site catalyst;
   polymerizing ethylene and an alpha-olefin in a second reactor with a multi-site catalyst;
   optionally polymerizing ethylene and an alpha-olefin in a third reactor with a single site catalyst or a multi-site catalyst;
   wherein the first, second and optional third reactor are configured in series with one another;
the method comprising:
   decreasing the alpha-olefin ratio split from a first higher value to a second lower value, wherein the alpha-olefin ratio split is defined by the equation:

$$F {1}_{α - olefin} \times F {2}_{ethylene} / ( F {1}_{α - olefin} \times F {2}_{ethylene} + F {2}_{α - olefin} \times F {1}_{ethylene} ) ;$$

where F1_{α-olefin} is the flow rate (in kg/hour) of alpha-olefin to the first reactor; F1_{ethylene} is the flow rate (in kg/hour) of ethylene to the first reactor; F2_{α-olefin} is the flow rate (in kg/hour) of alpha-olefin to the second reactor; and F2_{ethylene} is the flow rate (in kg/hour) of ethylene to the second reactor; and
   wherein the improvement of the optical properties of the ethylene copolymer composition is indicated by one or both of:
   a decrease in optical haze of a monolayer blown film which is made from the ethylene copolymer composition;
   an increase in gloss at 450 of a monolayer blown film which is made from the ethylene copolymer composition.

Provided is a method for improving the optical properties of an ethylene copolymer composition made in a solution phase polymerization process;
the solution phase polymerization process comprising:
   polymerizing ethylene and an alpha-olefin in a first reactor with a single site catalyst;
   polymerizing ethylene and an alpha-olefin in a second reactor with a multi-site catalyst;
   optionally polymerizing ethylene and an alpha-olefin in a third reactor with a single site catalyst or a multi-site catalyst;
   wherein the first, second and optional third reactor are configured in series with one another;
the method comprising:
   decreasing the alpha-olefin ratio split from a first higher value to a second lower value, wherein the alpha-olefin ratio split is defined by the equation:

$$F {1}_{α - olefin} \times F {2}_{ethylene} / ( F {1}_{α - olefin} \times F {2}_{ethylene} + F {2}_{α - olefin} \times F {1}_{ethylene} ) ;$$

where F1_{α-olefin} is the flow rate (in kg/hour) of alpha-olefin to the first reactor; F1_{ethylene} is the flow rate (in kg/hour) of ethylene to the first reactor; F2_{α-olefin} is the flow rate (in kg/hour) of alpha-olefin to the second reactor; and F2_{ethylene} is the flow rate (in kg/hour) of ethylene to the second reactor; and
   wherein the improvement of the optical properties of the ethylene copolymer composition is indicated by one or both of:
   a decrease in optical haze of a monolayer blown film having a thickness of about 1 mil and which is made from the ethylene copolymer composition;
   an increase in gloss at 450 of a monolayer blown film having a thickness of about 1 mil and which is made from the ethylene copolymer composition.

Provided is a method for improving the optical properties of an ethylene copolymer composition comprising a first ethylene copolymer, a second ethylene copolymer and optionally a third ethylene copolymer, wherein the ethylene copolymer composition is made in a solution phase polymerization process;
the solution phase polymerization process comprising:
   polymerizing ethylene and an alpha-olefin in a first reactor with a single site catalyst to give a first ethylene copolymer;
   polymerizing ethylene and an alpha-olefin in a second reactor with a multi-site catalyst to give a second ethylene copolymer;
   optionally polymerizing ethylene and an alpha-olefin in a third reactor with a single site catalyst or a multi-site catalyst to give a third ethylene copolymer;
   wherein the first, second and optional third reactor are configured in series with one another;
the method comprising:
   decreasing the alpha-olefin ratio split from a first higher value to a second lower value, wherein the alpha-olefin ratio split is defined by the equation:

$$F {1}_{α - olefin} \times F {2}_{ethylene} / ( F {1}_{α - olefin} \times F {2}_{ethylene} + F {2}_{α - olefin} \times F {1}_{ethylene} ) ;$$

where F1_{α-olefin} is the flow rate (in kg/hour) of alpha-olefin to the first reactor; F1_{ethylene} is the flow rate (in kg/hour) of ethylene to the first reactor; F2_{α-olefin} is the flow rate (in kg/hour) of alpha-olefin to the second reactor; and F2_{ethylene} is the flow rate (in kg/hour) of ethylene to the second reactor; and
   wherein the improvement of the optical properties of the ethylene copolymer composition is indicated by one or both of:
   a decrease in optical haze of a monolayer blown film which is made from the ethylene copolymer composition;
   an increase in gloss at 450 of a monolayer blown film which is made from the ethylene copolymer composition.

Provided is a method for improving the optical properties of an ethylene copolymer composition comprising a first ethylene copolymer, a second ethylene copolymer and optionally a third ethylene copolymer, wherein the ethylene copolymer composition is made in a solution phase polymerization process;
the solution phase polymerization process comprising:
   polymerizing ethylene and an alpha-olefin in a first reactor with a single site catalyst to give a first ethylene copolymer;
   polymerizing ethylene and an alpha-olefin in a second reactor with a multi-site catalyst to give a second ethylene copolymer;
   optionally polymerizing ethylene and an alpha-olefin in a third reactor with a single site catalyst or a multi-site catalyst to give a third ethylene copolymer;
   wherein the first, second and optional third reactor are configured in series with one another;
the method comprising:
   decreasing the alpha-olefin ratio split from a first higher value to a second lower value, wherein the alpha-olefin ratio split is defined by the equation:

$$F {1}_{α - olefin} \times F {2}_{ethylene} / ( F {1}_{α - olefin} \times F {2}_{ethylene} + F {2}_{α - olefin} \times F {1}_{ethylene} ) ;$$

where F1_{α-olefin} is the flow rate (in kg/hour) of alpha-olefin to the first reactor; F1_{ethylene} is the flow rate (in kg/hour) of ethylene to the first reactor; F2_{α-olefin} is the flow rate (in kg/hour) of alpha-olefin to the second reactor; and F2_{ethylene} is the flow rate (in kg/hour) of ethylene to the second reactor; and
   wherein the improvement of the optical properties of the ethylene copolymer composition is indicated by one or both of:
   a decrease in optical haze of a monolayer blown film having a thickness of about 1 mil and which is made from the ethylene copolymer composition;
   an increase in gloss at 450 of a monolayer blown film having a thickness of about 1 mil and which is made from the ethylene copolymer composition.

In an embodiment an alpha-olefin ratio split is decreased by 5 percent.

In an embodiment an alpha-olefin ratio split is decreased by 10 percent.

In an embodiment an alpha-olefin is 1-octene.

In an embodiment a single site catalyst is a phosphinimine catalyst.

In an embodiment a multi-site catalyst is a Ziegler-Natta catalyst.

In an embodiment an ethylene copolymer composition has a density of from 0.912 to 0.939 g/cm³.

In an embodiment an ethylene copolymer composition has a melt index, I₂ of from 0.1 to 10 g/10 min.

In an embodiment a polymerization temperature in the second reactor is higher than a polymerization temperature in the first reactor.

In an embodiment, a polymerization temperature in the second reactor is at least 30° C. higher than a polymerization temperature in the first reactor.

### BRIEF DESCRIPTION OF THE FIGURES

FIGS. 1, 2, 3, 4 and 5 show the CTREF profiles obtained for ethylene copolymer compositions made when employing the method of the present disclosure. FIGS. 1-5 illustrate a trend in the change in the elution location of a low temperature elution fraction: there is a shift of this peak toward higher temperatures, as the alpha-olefin ratio split is decreased.

FIG. 1 shows the CTREF profile for ethylene copolymer compositions made at different alpha-olefin ratio splits while targeting an ethylene copolymer composition having a density of about 0.919 g/cm³ and a melt index, I₂ of about 0.85 g/10 min.

FIG. 2 shows the CTREF profile for ethylene copolymer compositions made at different alpha-olefin ratio splits while targeting an ethylene copolymer composition having a density of about 0.918 g/cm³ and a melt index, I₂ of about 0.8 g/10 min.

FIG. 3 shows the CTREF profile for ethylene copolymer compositions made at different alpha-olefin ratio splits while targeting an ethylene copolymer composition having a density of about 0.914 g/cm³ and a melt index, I₂ of about 0.9 g/10 min.

FIG. 4 shows the CTREF profile for ethylene copolymer compositions made at different alpha-olefin ratio splits while targeting an ethylene copolymer composition having a density of about 0.912 to 0.913 g/cm³ and a melt index, I₂ of about 0.8 to 1.0 g/10 min.

FIG. 5 shows the CTREF profile for ethylene copolymer compositions made at different alpha-olefin ratio splits while targeting an ethylene copolymer composition having a density of about 0.908 g/cm³ and a melt index, I₂ of about 0.75 to 0.85 g/10 min.

### DEFINITION OF TERMS

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values.

As used herein, the term “monomer” refers to a small molecule that may chemically react and become chemically bonded with itself or other monomers to form a polymer.

As used herein, the term “α-olefin” or “alpha-olefin” is used to describe a monomer having a linear hydrocarbon chain containing from 3 to 20 carbon atoms having a double bond at one end of the chain; an equivalent term is “linear α-olefin”. As used herein, the term “polyethylene” or “ethylene polymer”, refers to macromolecules produced from ethylene monomers and optionally one or more additional monomers; regardless of the specific catalyst or specific process used to make the ethylene polymer. In the polyethylene art, the one or more additional monomers are called “comonomer(s)” and often include α-olefins. The term “homopolymer” refers to a polymer that contains only one type of monomer. An “ethylene homopolymer” is made using only ethylene as a polymerizable monomer. The term “copolymer” refers to a polymer that contains two or more types of monomer. An “ethylene copolymer” is made using ethylene and one or more other types of polymerizable monomer. Common polyethylenes include high density polyethylene (HDPE), medium density polyethylene (MDPE), linear low density polyethylene (LLDPE), very low density polyethylene (VLDPE), ultralow density polyethylene (ULDPE), plastomer and elastomers. The term polyethylene also includes polyethylene terpolymers which may include two or more comonomers in addition to ethylene. The term polyethylene also includes combinations of, or blends of, the polyethylenes described above.

The term “heterogeneously branched polyethylene” refers to a subset of polymers in the ethylene polymer group that are produced using a heterogeneous catalyst system; non-limiting examples of which include Ziegler-Natta or chromium catalysts, both of which are well known in the art.

The term “homogeneously branched polyethylene” refers to a subset of polymers in the ethylene polymer group that are produced using single-site catalysts; non-limiting examples of which include metallocene catalysts, phosphinimine catalysts, and constrained geometry catalysts all of which are well known in the art.

Typically, homogeneously branched polyethylenes have narrow molecular weight distributions, for example gel permeation chromatography (GPC) M_{w}/Mₙ values of less than about 2.8, especially less than about 2.3, although exceptions may arise; M_{w} and Mₙ refer to weight and number average molecular weights, respectively. In contrast, the M_{w}/Mₙ of heterogeneously branched ethylene polymers are typically greater than the M_{W}/Mₙ of homogeneous polyethylene. In general, homogeneously branched ethylene polymers also have a narrow composition distribution, i.e. each macromolecule within the molecular weight distribution has a similar comonomer content. Frequently, the composition distribution breadth index “CDBI” is used to quantify how the comonomer is distributed within an ethylene polymer, as well as to differentiate ethylene polymers produced with different catalysts or processes. The “CDBI₅₀” is defined as the percent of ethylene polymer whose composition is within 50 weight percent (wt %) of the median comonomer composition; this definition is consistent with that described in WO 93/03093 assigned to Exxon Chemical Patents Inc. The CDBI₅₀ of an ethylene copolymer can be calculated from TREF curves (Temperature Rising Elution Fractionation); the TREF method is described in Wild, et al., J. Polym. Sci., Part B, Polym. Phys., Vol. 20 (3), pages 441-455. Typically, the CDBI₅₀ of homogeneously branched ethylene polymers are greater than about 70% or greater than about 75%. In contrast, the CDBI₅₀ of α-olefin containing heterogeneously branched ethylene polymers are generally lower than the CDBI₅₀ of homogeneous ethylene polymers. For example, the CDBI₅₀ of a heterogeneously branched ethylene polymer may be less than about 75%, or less than about 70%.

As used herein, the terms “hydrocarbyl”, “hydrocarbyl radical” or “hydrocarbyl group” refers to linear or branched, aliphatic, olefinic, acetylenic and aryl (aromatic) radicals comprising hydrogen and carbon that are deficient by one hydrogen. The term “cyclic hydrocarbyl group” connotes hydrocarbyl groups that comprise cyclic moieties and which may have one or more than one cyclic aromatic ring, and/or one or more than one non-aromatic ring. The term “acyclic hydrocarbyl group” connotes hydrocarbyl groups that do not have cyclic moieties such as aromatic or non-aromatic ring structures present within them.

As used herein, the phrase “heteroatom” includes any atom other than carbon and hydrogen that can be bound to carbon. The term “heteroatom containing” or “heteroatom containing hydrocarbyl group” means that one or more than one non carbon atom(s) may be present in the hydrocarbyl groups. Some non-limiting examples of non-carbon atoms that may be present is a heteroatom containing hydrocarbyl group are N, O, S, P and Si as well as halides such as for example Br and metals such as Sn. Some non-limiting examples of heteroatom containing hydrocarbyl groups include for example aryloxy groups, alkoxy groups, alkylaryloxy groups, and arylalkoxy groups. Further non-limiting examples of heteroatom containing hydrocarbyl groups generally include for example imines, amine moieties, oxide moieties, phosphine moieties, ethers, ketones, heterocyclics, oxazolines, thioethers, and the like.

In an embodiment of the disclosure, a heteroatom containing hydrocarbyl group is a hydrocarbyl group containing from 1 to 3 atoms selected from the group consisting of boron, aluminum, silicon, germanium, nitrogen, phosphorous, oxygen and sulfur.

The terms “cyclic heteroatom containing hydrocarbyl” or “heterocyclic” refer to ring systems having a carbon backbone that further comprises at least one heteroatom selected from the group consisting of for example boron, aluminum, silicon, germanium, nitrogen, phosphorous, oxygen and sulfur.

In an embodiment of the disclosure, a cyclic heteroatom containing hydrocarbyl group is a cyclic hydrocarbyl group containing from 1 to 3 atoms selected from the group consisting of boron, aluminum, silicon, germanium, nitrogen, phosphorous, oxygen and sulfur.

As used herein, an “alkyl radical” or “alkyl group” includes linear, branched and cyclic paraffin radicals that are deficient by one hydrogen radical; non-limiting examples include methyl (—CH₃) and ethyl (—CH₂CH₃) radicals. The term “alkenyl radical” or “alkenyl group” refers to linear, branched and cyclic hydrocarbons containing at least one carbon-carbon double bond that is deficient by one hydrogen radical. The term “alkynyl radical” or “alkynyl group” refers to linear, branched and cyclic hydrocarbons containing at least one carbon-carbon triple bond that is deficient by one hydrogen radical.

As used herein, the term “aryl radical” or “aryl group” includes phenyl, naphthyl, pyridyl and other radicals whose molecules have an aromatic ring structure; non-limiting examples include naphthalene, phenanthrene and anthracene. An “alkylaryl” group is an alkyl group having an aryl group pendant there from; non-limiting examples include benzyl, phenethyl and tolylmethyl. An “arylalkyl” is an aryl group having one or more alkyl groups pendant there from; non-limiting examples include tolyl, xylyl, mesityl and cumyl.

An “alkoxy group” is an oxy group having an alkyl group pendant there from; and includes for example a methoxy group, an ethoxy group, an iso-propoxy group, and the like.

An “alkylaryloxy group” is an oxy group having an alkylaryl group pendent there from (for clarity, the alkyl moiety is bonded to the oxy moiety and the aryl group is bonded to the alkyl moiety).

An “aryloxy” group is an oxy group having an aryl group pendant there from; and includes for example a phenoxy group and the like. An “arylalkyloxy group” is an oxy group having an arylalkyl group pendent there from (for clarity, the aryl moiety is bonded to the oxy moiety and the alkyl group is bonded to the aryl moiety).

In the present disclosure, a hydrocarbyl group or a heteroatom containing hydrocarbyl group may be further specifically defined as being unsubstituted or substituted. As used herein the term “unsubstituted” means that hydrogen radicals are bounded to the molecular group that is referred to by the term unsubstituted. The term “substituted” means that the group referred to by this term possesses one or more moieties that have replaced one or more hydrogen radicals in any position within the group; non-limiting examples of moieties include halogen radicals (F, Cl, Br), an alkyl group, an alkylaryl group, an arylalkyl group, an alkoxy group, an aryl group, an aryloxy group, an amido group, a silyl group or a germanyl group, hydroxyl groups, carbonyl groups, carboxyl groups, amine groups, phosphine groups, phenyl groups, naphthyl groups, C₁ to C₁₀ alkyl groups, C₂ to C₁₀ alkenyl groups, and combinations thereof.

In embodiments of the disclosure, any hydrocarbyl group and/or any heteroatom containing hydrocarbyl group may be unsubstituted or substituted.

As used herein the term “monolayer film” refers to a film containing a single layer of an ethylene copolymer composition.

### DESCRIPTION OF EMBODIMENTS

The present disclosure provides a method to improve the optical properties of an ethylene copolymer composition which is made in a solution polymerization process.

In embodiments, the ethylene copolymer composition comprises a first ethylene copolymer, a second ethylene copolymer, and optionally a third ethylene copolymer.

In an embodiment the solution phase polymerization process comprises: i) polymerizing ethylene and an alpha-olefin in a first reactor with a single site catalyst; and ii) polymerizing ethylene and an alpha-olefin in a second reactor with a multi-site catalyst; wherein the first, and second polymerization reactors are configured in series with one another.

In an embodiment the solution phase polymerization process comprises: i) polymerizing ethylene and an alpha-olefin in a first reactor with a single site catalyst; ii) polymerizing ethylene and an alpha-olefin in a second reactor with a multi-site catalyst; and iii) optionally polymerizing ethylene and an alpha-olefin in a third reactor with a single site catalyst or a multi-site catalyst; wherein the first, second and optional third reactor are configured in series with one another.

In an embodiment the solution phase polymerization process comprises: i) polymerizing ethylene and an alpha-olefin in a first reactor with a single site catalyst; ii) polymerizing ethylene and an alpha-olefin in a second reactor with a multi-site catalyst; and iii) polymerizing ethylene and an alpha-olefin in a third reactor with a single site catalyst or a multi-site catalyst; wherein the first, second and optional third reactor are configured in series with one another.

In an embodiment the solution phase polymerization process comprises: i) polymerizing ethylene and an alpha-olefin in a first reactor with a single site catalyst to give a first ethylene copolymer; and ii) polymerizing ethylene and an alpha-olefin in a second reactor with a multi-site catalyst to give a second ethylene copolymer; wherein the first, and second polymerization reactors are configured in series with one another.

In an embodiment the solution phase polymerization process comprises: i) polymerizing ethylene and an alpha-olefin in a first reactor with a single site catalyst to give a first ethylene copolymer; ii) polymerizing ethylene and an alpha-olefin in a second reactor with a multi-site catalyst to give a second ethylene copolymer; and iii) optionally polymerizing ethylene and an alpha-olefin in a third reactor with a single site catalyst or a multi-site catalyst to give a third ethylene copolymer; wherein the first, second and optional third reactor are configured in series with one another.

In an embodiment the solution phase polymerization process comprises: i) polymerizing ethylene and an alpha-olefin in a first reactor with a single site catalyst to give a first ethylene copolymer; ii) polymerizing ethylene and an alpha-olefin in a second reactor with a multi-site catalyst to give a second ethylene copolymer; and iii) polymerizing ethylene and an alpha-olefin in a third reactor with a single site catalyst or a multi-site catalyst to give a third ethylene copolymer; wherein the first, second and optional third reactor are configured in series with one another.

In embodiments of the present disclosure, the method of improving the optical properties of an ethylene copolymer composition comprises decreasing the amount of an alpha-olefin which is fed to a first reactor, relative to the amount of alpha-olefin which is fed to a second reactor, wherein the first and second reactors are configured in series with one another.

In embodiments of the present disclosure the method of improving the optical properties of an ethylene copolymer composition comprises increasing the amount of an alpha-olefin which is fed to a second reactor, relative to the amount of alpha-olefin which is fed to a first reactor, wherein the first and second reactors are configured in series with one another.

The relative amounts of alpha-olefin which are fed to a first reactor and to a second reactor can in the present disclosure be characterized by the “alpha-olefin ratio split”, where the alpha-olefin ratio split is defined by the equation:

$$F {1}_{α - olefin} \times F {2}_{ethylene} / ( F {1}_{α - olefin} \times F {2}_{ethylene} + F {2}_{α - olefin} \times F {1}_{ethylene} ) ;$$

where F1_{α-olefin} is the flow rate (in kg/hour) of alpha-olefin fed to the first reactor; F1_{ethylene} is flow rate (in kg/hour) of ethylene fed to the first reactor; F2_{α-olefin} is flow rate (in kg/hour) of alpha-olefin fed to the second reactor; and F2_{ethylene} is the flow rate (in kg/hour) of ethylene fed to the second reactor.

In an embodiment of the disclosure, a method for improving the optical properties of an ethylene copolymer composition comprises decreasing the alpha-olefin ratio split from a first higher value to a second lower value.

In embodiments, a method for improving the optical properties of an ethylene copolymer composition comprises decreasing the alpha-olefin ratio split from a first higher value to a second lower value by at least 1 percent, or by at least 3 percent, or by at least 5 percent, or by at least 7.5 percent, or by at least 10 percent, or by at least 15 percent, or by at least 20 percent, or by at least 25 percent, or by at least 30 percent, or by at least 40 percent, or by at least 50 percent.

In an embodiment of the present disclosure, an improvement of the optical properties of an ethylene copolymer composition is indicated by a decrease in the optical haze of a monolayer blown film which is made from the ethylene copolymer composition.

In an embodiment of the present disclosure, an improvement of the optical properties of an ethylene copolymer composition is indicated by an increase in the gloss at 450 value of a monolayer blown film which is made from the ethylene copolymer composition.

A person skilled in the art will recognize that the optical properties of an ethylene copolymer composition may be determined for a monolayer blown film having any thickness and which is made from the ethylene copolymer composition, but that the trend in the measured optical property is expected to be the same regardless of the thickness of the film used to measure the optical property. And so, in embodiments of the disclosure an improvement of the optical properties of an ethylene copolymer composition is indicated by a decrease in the optical haze of a monolayer blown film having any thickness, and which is made from the ethylene copolymer composition. Alternatively, in embodiments of the disclosure an improvement of the optical properties of an ethylene copolymer composition is indicated by an increase in the gloss at 450 value of a monolayer blown film having any thickness, and which is made from the ethylene copolymer composition.

In an embodiment of the present disclosure, an improvement of the optical properties of an ethylene copolymer composition is indicated by both: i) a decrease in the optical haze of a monolayer blown film which is made from the ethylene copolymer composition; and ii) an increase in the gloss at 450 value of a monolayer blown film which is made from the ethylene copolymer composition.

In an embodiment of the present disclosure, an improvement of the optical properties of an ethylene copolymer composition is indicated by one or both of: i) a decrease in the optical haze of a monolayer blown film which is made from the ethylene copolymer composition; and ii) an increase in the gloss at 450 value of a monolayer blown film which is made from the ethylene copolymer composition.

In an embodiment of the present disclosure, an improvement of the optical properties of an ethylene copolymer composition is indicated by a decrease in the optical haze of a monolayer blown film having a thickness of about 1 mil and which is made from the ethylene copolymer composition. However, a person skilled in the art will recognize that the optical haze of a monolayer blown film may be determined on a blown film having any thickness.

In an embodiment of the present disclosure, an improvement of the optical properties of an ethylene copolymer composition is indicated by an increase in the gloss at 450 value of a monolayer blown film having a thickness of about 1 mil and which is made from the ethylene copolymer composition. However, a person skilled in the art will recognize that the gloss at 450 value of a monolayer blown film may be determined on a blown film having any thickness.

In an embodiment of the present disclosure, an improvement of the optical properties of an ethylene copolymer composition is indicated by both: i) a decrease in the optical haze of a monolayer blown film having a thickness of about 1 mil and which is made from the ethylene copolymer composition; and ii) an increase in the gloss at 450 value of a monolayer blown film having a thickness of about 1 mil and which is made from the ethylene copolymer composition. However, a person skilled in the art will recognize that the optical haze and the gloss at 450 value of a monolayer blown film may be determined on a blown film having any thickness.

In an embodiment of the present disclosure, an improvement of the optical properties of an ethylene copolymer composition is indicated by one or both of: i) a decrease in the optical haze of a monolayer blown film having a thickness of about 1 mil and which is made from the ethylene copolymer composition; and ii) an increase in the gloss at 450 value of a monolayer blown film having a thickness of about 1 mil and which is made from the ethylene copolymer composition. However, a person skilled in the art will recognize that the optical haze and the gloss at 450 value of a monolayer blown film may be determined on a blown film having any thickness.

The optical haze of a film, including a blown film, made from an ethylene copolymer composition may be determined using ASTM D1003-13 (Nov. 15, 2013).

The gloss at 450 of a film, including a blown film, made from an ethylene copolymer composition may be determined using ASTM D2457-13 (Apr. 1, 2013).

In embodiments, the method of the present disclosure decreases the optical haze of a monolayer blown film having a thickness of 1 mil and which is made from an ethylene copolymer composition by at least 1 percent, or at least 3 percent, or at least 5 percent, or at least 7.5 percent, or at least 10 percent, or at least 15 percent, or at least 20 percent, or at least 25 percent (where the decrease in optical haze is defined as the original haze value minus the final haze value divided by the original haze value×100%).

In embodiments, the method of the present disclosure increases the gloss at 450 value of a monolayer blown film having a thickness of 1 mil and which is made from an ethylene copolymer composition by at least 1 percent, or at least 3 percent, or at least 5 percent, or at least 7.5 percent, or at least 10 percent, or at least 15 percent, or at least 20 percent, or at least 25 percent, or at least 30 percent (where the increase in gloss is defined as the final gloss at 450 value minus the original gloss at 450 value divided by the original gloss at 450 value×100%).

In embodiments of the disclosure, decreasing the alpha-olefin ratio split from a first higher value to a second lower value decreases the optical haze of a monolayer blown film which is made from an ethylene copolymer composition.

In embodiments of the disclosure, decreasing the alpha-olefin ratio split from a first higher value to a second lower value decreases the optical haze of a monolayer blown film having a thickness of 1 mil which is made from an ethylene copolymer composition.

In embodiments of the disclosure, decreasing the alpha-olefin ratio split from a first higher value to a second lower value increases the gloss at 450 value of a monolayer blown film which is made from an ethylene copolymer composition.

In embodiments of the disclosure, decreasing the alpha-olefin ratio split from a first higher value to a second lower value increases the gloss at 450 value of a monolayer blown film having a thickness of 1 mil which is made from an ethylene copolymer composition.

In embodiments of the disclosure, decreasing the alpha-olefin ratio split from a first higher value to a second lower value by at least 1 percent, or by at least 3 percent, or by at least 5 percent, or by at least 7.5 percent, or by at least 10 percent, or by at least 15 percent, or by at least 20 percent, or by at least 25 percent, or by at least 30 percent, or by at least 40 percent, or by at least 50 percent, decreases the optical haze of a monolayer blown film having a thickness of 1 mil which is made from an ethylene copolymer composition by at least 1 percent, or at least 3 percent, or at least 5 percent, or at least 7.5 percent, or at least 10 percent, or at least 15 percent, or at least 20 percent, or at least 25 percent (where the decrease in optical haze is defined as the original haze value minus the final haze value divided by the original haze value×100%).

In embodiments of the disclosure, decreasing the alpha-olefin ratio split from a first higher value to a second lower value by at least 1 percent, or by at least 3 percent, or by at least 5 percent, or by at least 7.5 percent, or by at least 10 percent, or by at least 15 percent, or by at least 20 percent, or by at least 25 percent, or by at least 30 percent, or by at least 40 percent, or by at least 50 percent, increases the gloss at 450 value of a monolayer blown film having a thickness of 1 mil which is made from an ethylene copolymer composition by at least 1 percent, or at least 3 percent, or at least 5 percent, or at least 7.5 percent, or at least 10 percent, or at least 15 percent, or at least 20 percent, or at least 25 percent, or at least 30 percent (where the increase in gloss is defined as the final gloss at 450 value minus the original gloss at 450 value divided by the original gloss at 450 value×100%).

In embodiments of the disclosure, decreasing the alpha-olefin ratio split from a first higher value to a second lower value increases the temperature at which the lowest temperature peak in an ethylene copolymer composition elutes in a temperature rising elution fractionation (TREF) analysis as obtained using a CTREF instrument (a “CRYSTAF/Temperature Rising Elution Fractionation instrument”).

In embodiments of the disclosure, decreasing the alpha-olefin ratio split from a first higher value to a second lower value by at least 1 percent, or by at least 3 percent, or by at least 5 percent, or by at least 7.5 percent, or by at least 10 percent, or by at least 15 percent, or by at least 20 percent, or by at least 25 percent, or by at least 30 percent, or by at least 40 percent, or by at least 50 percent, increases the temperature at which the lowest temperature peak in an ethylene copolymer composition elutes in a temperature rising elution fractionation (TREF) analysis as obtained using a CTREF instrument (a “CRYSTAF/Temperature Rising Elution Fractionation instrument”) by at least 1° C., or at least 3° C., or at least 5° C., or at least 7.5° C., or at least 10° C., or at least 15° C., or at least 20° C.

In embodiments of the disclosure, decreasing the alpha-olefin ratio split from a first higher value to a second lower value increases the CDBI₅₀ value of an ethylene copolymer composition as obtained using a CTREF instrument (a “CRYSTAF/Temperature Rising Elution Fractionation instrument”).

In embodiments of the disclosure, decreasing the alpha-olefin ratio split from a first higher value to a second lower value by at least 1 percent, or by at least 3 percent, or by at least 5 percent, or by at least 7.5 percent, or by at least 10 percent, or by at least 15 percent, or by at least 20 percent, or by at least 25 percent, or by at least 30 percent, or by at least 40 percent, or by at least 50 percent, increases the CDBI₅₀ value of an ethylene copolymer composition as obtained using a CTREF instrument (a “CRYSTAF/Temperature Rising Elution Fractionation instrument”).

A person skilled in the art will understand that as the alpha-olefin ratio split is altered, there may be a consequential impact on polymerization process and/or polymer product variables, such as, for example, the polymerization production rate, the properties of the overall ethylene copolymer composition, and the properties of the ethylene copolymer composition components formed in each reactor (i.e. the first ethylene copolymer, the second ethylene copolymer and the optional third ethylene copolymer). Accordingly, in further embodiments of the disclosure any number of other polymerization process variables (other than the alpha-olefin ratio split) may be varied in order to maintain polymerization production rates, and/or to maintain overall ethylene copolymer composition and ethylene copolymer composition component properties within certain specification ranges. Such polymerization process variables, which can be manipulated within one or more of the polymerization reactors, in embodiments of the present disclosure, include but are not limited to changing the hydrogen concentration, the reactor temperature, the catalyst component concentrations, the catalyst component ratios, the ethylene concentrations, and the ethylene conversion in each of a first polymerization reactor, a second polymerization reactor, and optionally a third polymerization reactor. Another polymerization process variable which can be manipulated within one or more of the polymerization reactors, in embodiments of the present disclosure, includes changing the overall alpha-olefin to ethylene ratio, where the overall alpha-olefin to ethylene ratio, in this context, considers the total amounts of alpha-olefin and ethylene fed to all reactors.

In an embodiment of the disclosure, the optical properties of an ethylene copolymer composition made in a solution phase polymerization process are improved by decreasing the alpha-olefin ratio split, while also optimizing other polymerization process conditions, including making changes to one or more of the following:
i) the overall alpha-olefin to ethylene ratio;
ii) the hydrogen concentration in one or more of a first reactor, a second reactor, and an optionally third reactor;
iii) the reactor temperature in one or more of a first reactor, a second reactor, and an optionally third reactor;
iv) the ethylene concentration in one or more of a first reactor, a second reactor, and an optionally third reactor;
v) the ethylene conversion in one or more of a first reactor, a second reactor, and an optionally third reactor;
vi) the catalyst component concentrations in one or more of a first reactor, a second reactor, and an optionally third reactor; and
vii) the catalyst component ratios in one or more of a first reactor, a second reactor, and an optionally third reactor.

In an embodiment, a first reactor, a second reactor, and an optional third reactor are each a continuously stirred tank reactor or a tubular reactor.

In an embodiment, a first reactor, a second reactor, and an optional third reactor are each a continuously stirred tank reactor.

In an embodiment, a first reactor, a second reactor, and an optional third reactor are each a tubular reactor.

In an embodiment, a first reactor, and a second reactor are a continuously stirred tank reactor, and a third reactor is a tubular reactor.

In an embodiment, a first reactor and a second reactor are configured in series with one another, so that the polymer solution effluent of the first reactor flows in the second reactor.

In an embodiment, a first reactor, a second reactor, and a third reactor are configured in series with one another, so that the polymer solution effluent of the first reactor flows in the second reactor, and the polymer solution effluent of the second reactor flows into the third reactor.

In solution polymerization, the monomers are dissolved/dispersed in the solvent either prior to being fed to the reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, and may in various embodiments include molecular sieves, alumina beds and oxygen removal catalysts for the purification of monomers. The solvent itself as well (e.g. methyl pentane, cyclohexane, hexane or toluene) may be treated in a similar manner.

The feedstock monomers or other solution process components (e.g., solvent) may be heated or cooled prior to feeding to a solution phase polymerization reactor.

Generally, the catalyst components may be premixed in the solvent for the polymerization reaction or fed as separate streams to a reactor. In some instances premixing catalyst components may be desirable to provide a reaction time for the catalyst components prior to entering a polymerization reactor. Such an “in line mixing” technique is described in a number of patents in the name of DuPont Canada Inc. (e.g. U.S. Pat. No. 5,589,555).

Solution polymerization processes for the polymerization or copolymerization of ethylene are well known in the art (see for example U.S. Pat. Nos. 6,372,864 and 6,777,509). These processes are conducted in the presence of an inert hydrocarbon solvent. In a solution phase polymerization reactor, a variety of solvents may be used as the process solvent; non-limiting examples include linear, branched or cyclic C₅ to C₁₂ alkanes. Non-limiting examples of α-olefins include 1-propene, 1-butene, 1-pentene, 1-hexene and 1-octene. Suitable catalyst component solvents include aliphatic and aromatic hydrocarbons. Non-limiting examples of aliphatic catalyst component solvents include linear, branched or cyclic C₅₋₁₂ aliphatic hydrocarbons, e.g. pentane, methyl pentane, hexane, heptane, octane, cyclohexane, cyclopentane, methylcyclohexane, hydrogenated naphtha or combinations thereof. Non-limiting examples of aromatic catalyst component solvents include benzene, toluene (methylbenzene), ethylbenzene, o-xylene (1,2-dimethylbenzene), m-xylene (1,3-dimethylbenzene), p-xylene (1,4-dimethylbenzene), mixtures of xylene isomers, hemellitene (1,2,3-trimethylbenzene), pseudocumene (1,2,4-trimethylbenzene), mesitylene (1,3,5-trimethylbenzene), mixtures of trimethylbenzene isomers, prehenitene (1,2,3,4-tetramethylbenzene), durene (1,2,3,5-tetramethylbenzene), mixtures of tetramethylbenzene isomers, pentamethylbenzene, hexamethylbenzene and combinations thereof.

In embodiments, the polymerization temperature in a conventional solution process may be from about 80° C. to about 300° C. In an embodiment of the disclosure the polymerization temperature in a solution process is from about 120° C. to about 250° C. In an embodiment of the disclosure the polymerization temperature in a solution phase polymerization process is from about 120° C. to about 250° C. In further embodiments, a solution phase polymerization process is carried out at a temperature of at least 140° C., or at least 160° C., or at least 170° C., or at least 180° C., or at least 190° C.

In embodiments, the polymerization pressure in a solution phase polymerization process may be a “medium pressure process”, meaning that the pressure in a polymerization reactor is less than about 6,000 psi (about 42,000 kiloPascals or kPa). In embodiments of the disclosure, the polymerization pressure in a solution phase polymerization process (or inside a polymerization reactor) may be from about 10,000 to about 40,000 kPa, or from about 14,000 to about 22,000 kPa (i.e. from about 2,000 psi to about 3,000 psi).

In embodiments, suitable monomers for copolymerization with ethylene include C₃₋₂₀ mono- and di-olefins. In some embodiments, comonomers include C₃₋₁₂ alpha olefins which are unsubstituted or substituted by up to two C₁₋₆ alkyl radicals, C₈₋₁₂ vinyl aromatic monomers which are unsubstituted or substituted by up to two substituents selected from the group consisting of C₁₋₄ alkyl radicals, C₄₋₁₂ straight chained or cyclic diolefins which are unsubstituted or substituted by a C₁₋₄ alkyl radical. Illustrative non-limiting examples of such alpha-olefins are one or more of propylene, 1-butene, 1-pentene, 1-hexene, 1-octene and 1-decene, styrene, alpha methyl styrene, and the constrained-ring cyclic olefins such as cyclobutene, cyclopentene, dicyclopentadiene norbornene, alkyl-substituted norbornenes, alkenyl-substituted norbornenes and the like (e.g. 5-methylene-2-norbornene and 5-ethylidene-2-norbornene, bicyclo-(2,2,1)-hepta-2,5-diene).

In an embodiment of the disclosure, the polymerization process comprises polymerizing ethylene with one or more of an alpha-olefin selected from the group consisting of 1-butene, 1-hexene, 1-octene and mixtures thereof.

In an embodiment of the disclosure, the polymerization process comprises polymerizing ethylene with 1-octene.

In an embodiment of the disclosure, a solution phase polymerization process is a continuous process. By the term “continuous process” it is meant that the polymerization process flows (e.g., solvent, ethylene, optional alpha-olefin comonomer, olefin polymerization catalyst system components, etc.) are continuously fed to a polymerization zone (e.g., a polymerization reactor) where a polymer (e.g., ethylene homopolymer or ethylene copolymer) is formed and from which the polymer is continuously removed via a process flow effluent steam.

In an embodiment of the disclosure, the pressure in a continuous solution phase polymerization reactor is from 10.3 to 31 MPa. In another embodiment of the disclosure, the pressure in a continuous solution phase polymerization reactor is from 10.5 to 21 MPa.

In an embodiment of the disclosure, a solution phase polymerization process is carried out in at least one continuously stirred tank reactor (a “CSTR”).

In an embodiment of the disclosure, a solution phase polymerization process is carried out in at least two sequentially arranged continuously stirred tank reactors (with the process flows being transferred from a first upstream CSTR reactor to a second downstream CSTR).

In an embodiment of the disclosure, a solution phase polymerization process is carried out in at least two sequentially arranged continuously stirred tank reactors (with the process flows being transferred from a first upstream CSTR to a second downstream CSTR) and the downstream reactor is operated at a higher temperature than the upstream reactor.

In an embodiment of the disclosure, a solution phase polymerization process is carried out in at least two sequentially arranged continuously stirred tank reactors (with the process flows being transferred from a first upstream CSTR to a second downstream CSTR) and the downstream reactor is operated at a lower pressure than the upstream reactor.

In an embodiment of the disclosure, a solution phase polymerization process is carried out in at least two sequentially arranged reactors (with the process flows being transferred from a first upstream reactor to a second downstream reactor) and the downstream reactor is operated at a higher temperature than the upstream reactor.

In an embodiment of the disclosure, a solution phase polymerization process is carried out in at least two sequentially arranged reactors (with the process flows being transferred from a first upstream reactor to a second downstream reactor) and the downstream reactor is operated at a lower pressure than the upstream reactor.

In an embodiment of the disclosure, a solution phase polymerization process is carried out in at least two sequentially arranged continuously stirred tank reactors, with the process flows being transferred from a first upstream CSTR to a second downstream CSTR, and the second CSTR is operated at a temperature which is at least 10° C. higher than the temperature at which the first CSTR is operated. In further embodiments of the disclosure, a solution phase polymerization process is carried out in at least two sequentially arranged continuously stirred tank reactors, with the process flows being transferred from a first upstream CSTR to a second downstream CSTR, and the second CSTR is operated at a temperature which is at least 20° C. higher, or at least 30° C. higher, or at least 40° C. higher, or at least 50° C. higher than the temperature at which the first CSTR is operated.

In an embodiment of the disclosure, a solution phase polymerization process is carried out in at least two sequentially arranged reactors, with the process flows being transferred from a first upstream reactor to a second downstream reactor, and the second reactor is operated at a temperature which is at least 10° C. higher than the temperature at which the first reactor is operated. In further embodiments of the disclosure, a solution phase polymerization process is carried out in at least two sequentially arranged reactors, with the process flows being transferred from a first upstream reactor to a second downstream reactor, and the second reactor is operated at a temperature which is at least 20° C. higher, or at least 30° C. higher, or at least 40° C., or at least 50° C. higher than the temperature at which the first reactor is operated.

In an embodiment of the disclosure, a solution phase polymerization process is carried out in at least one tubular reactor.

In an embodiment of the disclosure, a solution phase polymerization process is carried out in two sequentially arranged continuously stirred tank reactors and a tubular reactor which receives process flows from the second continuously stirred tank reactor.

In a solution phase polymerization process generally, a reactor is operated under conditions which achieve a thorough mixing of the reactants and the residence time (or alternatively, the “hold up time”) of the olefin polymerization catalyst (e.g., a single site catalyst or a multi-site catalyst) in a reactor will depend on the design and the capacity of the reactor.

In embodiments, the residence time of the olefin polymerization catalyst (e.g., a single site catalyst or a multi-site catalyst) in a given reactor will be from a few seconds to about 20 minutes. In further embodiments, the residence time of an olefin polymerization catalyst in a given reactor will be less than about 10 minutes, or less than about 5 minutes, or less than about 3 minutes.

If more than one CSTR is employed, olefin polymerization catalyst system components can be added to each of the CSTR(s) in order to maintain a high polymer production rate in each reactor.

In an embodiment a mixed catalyst system is used in which one olefin polymerization catalyst is a single site catalyst and one olefin polymerization catalyst is a Ziegler-Natta catalyst, where the single site catalyst is employed in a first CSTR and the Ziegler-Natta catalyst is be employed in a second CSTR.

The term “tubular reactor” is meant to convey its conventional meaning: namely a simple tube, which unlike a CSTR is generally not agitated using an impeller, stirrer or the like. In embodiments, a tubular reactor will have a length/diameter (L/D) ratio of at least 10/1. In embodiments, a tubular reactor is operated adiabatically. By way of a general non-limiting description and without wishing to be bound by theory, in a tubular reactor, as a polymerization reaction progresses, the monomer (e.g., ethylene) and/or comonomer (e.g., alpha-olefin) is increasingly consumed and the temperature of the solution increases along the length of the tube (which may improve the efficiency of separating the unreacted comonomer from the polymer solution). In embodiments, the temperature increase along the length of a tubular reactor may be greater than about 3° C. In embodiments, a tubular reactor is located downstream of a CSTR, and the discharge temperature from the tubular reactor may be at least about 3° C. greater than the discharge temperature from the CSTR (and from which process flows are fed to the tubular reactor).

In embodiments, a tubular reactor may have feed ports for the addition of additional polymerization catalyst system components such as single site pre-polymerization catalysts, Zielger-Natta catalyst components, catalyst activators, cocatalysts, and hindered phenol compounds, or for the addition of monomer, comonomer, hydrogen, etc. In an alternative embodiment, no additional polymerization catalyst components are added to a tubular reactor.

In an embodiment, the total volume of a tubular reactor used in combination with at least one CSTR is at least about 10 volume percent (vol %) of the volume of at the least one CSTR, or from about 30 vol % to about 200 vol % of the at least one CSTR (for clarity, if the volume of the at least one CSTR is 1,000 liters, then the volume of the tubular reactor is at least about 100 liters, or from about 300 to 2,000 liters).

In embodiments, on leaving the reactor system, non-reactive components may be removed (and optionally recovered) and the resulting polymer (e.g. an ethylene copolymer composition) may be finished in a conventional manner (e.g. using a devolatilization process). In an embodiment, a two-stage devolatilization process may be employed to recover a polymer (e.g. an ethylene copolymer composition) from a polymerization process solvent.

In embodiments, an ethylene copolymer composition will comprise at least a first ethylene copolymer which is made in a first reactor, and a second ethylene copolymer which is made in a second reactor.

In embodiments, an ethylene copolymer composition may optionally comprise a third ethylene copolymer which is made in an optional third reactor.

Embodiments of each of these ethylene copolymer components and the ethylene copolymer composition of which they are a part are further described below.

### The First Ethylene Copolymer

In an embodiment of the disclosure, the first ethylene copolymer is made with a single site catalyst, non-limiting examples of which include phosphinimine catalysts, metallocene catalysts, and constrained geometry catalysts, all of which are well known in the art.

In embodiments of the disclosure, alpha-olefins which may be copolymerized with ethylene to make the first ethylene copolymer may be selected from the group comprising 1-propene, 1-butene, 1-pentene, 1-hexene and 1-octene and mixtures thereof.

In an embodiment of the disclosure, the first ethylene copolymer is a homogeneously branched ethylene copolymer.

In an embodiment of the disclosure, the first ethylene copolymer is an ethylene/1-octene copolymer.

In an embodiment of the disclosure, the first ethylene copolymer is made with a phosphinimine catalyst represented by formula (I):

(L^{A})ₐM(PI)_{b}(Q)ₙ (I)

wherein (L^{A}) represents a bulky ligand; M represents a metal atom; PI represents a phosphinimine ligand; Q is independently an activatable leaving group ligand; a is 0 or 1; b is 1 or 2; (a+b)=2; n is 1 or 2; and the sum of (a+b+n) equals the valance of the metal M.

In an embodiment of the disclosure, L^{A} is selected from the group consisting of unsubstituted cyclopentadienyl, substituted cyclopentadienyl, unsubstituted indenyl, substituted indenyl, unsubstituted fluorenyl and substituted fluorenyl.

In an embodiment of the disclosure, M is a metal selected from the group consisting of titanium, hafnium and zirconium In further non-limiting embodiments of the disclosure, the bulky ligand L^{A} in formula (I) includes unsubstituted or substituted cyclopentadienyl ligands or cyclopentadienyl-type ligands, heteroatom substituted and/or heteroatom containing cyclopentadienyl-type ligands. In additional non-limiting embodiments, the bulky ligand L^{A} in formula (I) includes cyclopentaphenanthreneyl ligands, unsubstituted or substituted indenyl ligands, benzindenyl ligands, unsubstituted or substituted fluorenyl ligands, octahydrofluorenyl ligands, cyclooctatetraendiyl ligands, cyclopentacyclododecene ligands, azenyl ligands, azulene ligands, pentalene ligands, phosphoyl ligands, phosphinimine, pyrrolyl ligands, pyrozolyl ligands, carbazolyl ligands, borabenzene ligands and the like, including hydrogenated versions thereof, for example tetrahydroindenyl ligands. In other embodiments, L^{A} may be any other ligand structure capable of f-bonding to the metal M, such embodiments include both η³-bonding and η⁵-bonding to the metal M. In other embodiments, L^{A} may comprise one or more heteroatoms, for example, nitrogen, silicon, boron, germanium, sulfur and phosphorous, in combination with carbon atoms to form an open, acyclic, or a fused ring, or ring system, for example, a heterocyclopentadienyl ancillary ligand. Other non-limiting embodiments for L^{A} include bulky amides, phosphides, alkoxides, aryloxides, imides, carbolides, borollides, porphyrins, phthalocyanines, corrins and other polyazomacrocycles.

In an embodiment of the disclosure, the metal M is titanium, Ti.

The phosphinimine ligand, PI, is defined by formula (II):

$${( {R}^{p} )}_{3} P = N - \qquad ( II )$$

wherein the RP groups are independently selected from: a hydrogen atom; a halogen atom; C₁₋₂₀ hydrocarbyl radicals which are unsubstituted or substituted with one or more halogen atom(s); a C₁₋₈ alkoxy radical; a C₆₋₁₀ aryl radical; a C₆₋₁₀ aryloxy radical; an amido radical; a silyl radical of formula —Si(R^{S})₃, wherein the R^{S} groups are independently selected from, a hydrogen atom, a C₁₋₈ alkyl or alkoxy radical, a C₆₋₁₀ aryl radical, a C₆₋₁₀ aryloxy radical, or a germanyl radical of formula —Ge(R^{G})₃, wherein the R^{G} groups are defined as R^{S} is defined in this paragraph.

In an embodiment of the disclosure, the first ethylene copolymer is made with a metallocene catalyst.

In an embodiment of the disclosure, the first ethylene copolymer is made with a bridged metallocene catalyst.

In an embodiment of the disclosure, the first ethylene copolymer is made with a bridged metallocene catalyst having the formula III:

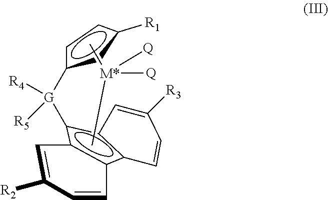

In Formula (II): M* is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, R₄ and R₅ are independently an aryl group.

In an embodiment, R₄ and R₅ are independently a phenyl group or a substituted phenyl group.

In an embodiment, R₄ and R₅ are a phenyl group.

In an embodiment, R₄ and R₅ are independently a substituted phenyl group.

In an embodiment, R₄ and R₅ are a substituted phenyl group, wherein the phenyl group is substituted with a substituted silyl group.

In an embodiment, R₄ and R₅ are a substituted phenyl group, wherein the phenyl group is substituted with a trialkyl silyl group.

In an embodiment, R₄ and R₅ are a substituted phenyl group, wherein the phenyl group is substituted at the para position with a trialkylsilyl group. In an embodiment, R¹ and R² are a substituted phenyl group, wherein the phenyl group is substituted at the para position with a trimethylsilyl group. In an embodiment, R¹ and R² are a substituted phenyl group, wherein the phenyl group is substituted at the para position with a triethylsilyl group.

In an embodiment, R₄ and R₅ are independently an alkyl group.

In an embodiment, R₄ and R₅ are independently an alkenyl group.

In an embodiment, R₁ is hydrogen.

In an embodiment, R₁ is an alkyl group.

In an embodiment, R₁ is an aryl group.

In an embodiment, R₁ is an alkenyl group.

In an embodiment, R₂ and R₃ are independently a hydrocarbyl group having from 1 to 30 carbon atoms.

In an embodiment, R₂ and R₃ are independently an aryl group.

In an embodiment, R₂ and R₃ are independently an alkyl group.

In an embodiment, R₂ and R₃ are independently an alkyl group having from 1 to 20 carbon atoms.

In an embodiment, R₂ and R₃ are independently a phenyl group or a substituted phenyl group.

In an embodiment, R₂ and R₃ are a tert-butyl group.

In an embodiment, R₂ and R₃ are hydrogen.

In an embodiment, M* is hafnium, Hf.

In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g. a halide may be converted to an alkyl group).

Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g. 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g. chloride) or a hydrocarbyl (e.g. methyl, benzyl).

In an embodiment of the disclosure, the single site catalyst used to make the first polyethylene is cyclopentadienyl tri(tertiarybutyl)phosphinimine titanium dichloride, Cp((t-Bu)₃PN)TiCl₂.

In an embodiment of the disclosure, the single site catalyst used to make the first polyethylene is cyclopentadienyl tri(tertiarybutyl)phosphinimine titanium dimethide, Cp((t-Bu)₃PN)TiMe₂.

In an embodiment of the disclosure, the single site catalyst used to make the first ethylene copolymer is diphenylmethylene(cyclopentadienyl)(2,7-di-t-butylfluorenyl)hafnium dichloride having the molecular formula: [(2,7-tBu₂Flu)Ph₂C(Cp)HfCl₂].

In an embodiment of the disclosure the single site catalyst used to make the first ethylene copolymer is diphenylmethylene(cyclopentadienyl)(2,7-di-t-butylfluorenyl)hafnium dimethide having the molecular formula: [(2,7-tBu₂Flu)Ph₂C(Cp)HfMe_{2].}

In addition to the single site catalyst molecule per se, an active single site catalyst system may further comprise one or more of the following: an alkylaluminoxane co-catalyst and an ionic activator. The single site catalyst system may also optionally comprise a hindered phenol.

Although the exact structure of alkylaluminoxane is uncertain, subject matter experts generally agree that it is an oligomeric species that contain repeating units of the general formula:

(R)₂AlO—(Al(R)—O)₁—Al(R)₂

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In an embodiment of the disclosure, R of the alkylaluminoxane, is a methyl radical and m is from 10 to 40.

In an embodiment of the disclosure, the co-catalyst is modified methylaluminoxane (MMAO).

It is well known in the art, that the alkylaluminoxane can serve dual roles as both an alkylator and an activator. Hence, an alkylaluminoxane co-catalyst is often used in combination with activatable ligands such as halogens.

In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas shown below:

[R⁵]⁺[B(R⁷)₄]⁻

where B represents a boron atom, R⁵ is an aromatic hydrocarbyl (e.g. triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula —Si(R⁹)₃, where each R⁹ is independently selected from hydrogen atoms and C₁₋₄ alkyl radicals, and

[(R⁸)ₜZH]⁺[B(R⁷)₄]⁻

where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above.

In both formula a non-limiting example of R⁷ is a pentafluorophenyl radical. In general, boron ionic activators may be described as salts of tetra(perfluorophenyl) boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl)ₙ-butylboron, N,N-2,4,6-pentamethylanilinium tetra(phenyl)boron, di-(isopropyl)ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene(diazonium)tetrakispentafluorophenyl borate, tropillium tetrakis(2,3,5,6-tetrafluorophenyl)borate, triphenylmethylium tetrakis(2,3,5,6-tetrafluorophenyl)borate, benzene(diazonium) tetrakis(3,4,5-trifluorophenyl)borate, tropillium tetrakis(3,4,5-trifluorophenyl)borate, benzene(diazonium) tetrakis(3,4,5-trifluorophenyl)borate, tropillium tetrakis(1,2,2-trifluoroethenyl)borate, triphenylmethylium tetrakis(1,2,2-trifluoroethenyl)borate, benzene(diazonium) tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene(diazonium) tetrakis(2,3,4,5 tetrafluorophenyl)borate. Readily available commercial ionic activators include N,N-dimethylanilinium tetrakispentafluorophenyl borate, and triphenylmethylium tetrakispentafluorophenyl borate.

Non-limiting example of hindered phenols include butylated phenolic antioxidants, butylated hydroxytoluene, 2,6-di-tertiarybutyl-4-ethyl phenol, 4,4′-methylenebis (2,6-di-tertiary-butylphenol), 1,3,5-trimethyl-2,4,6-tris (3,5-di-tert-butyl-4-hydroxybenzyl) benzene and octadecyl-3-(3′,5′-di-tert-butyl-4′-hydroxyphenyl) propionate.

To produce an active single site catalyst system the quantity and mole ratios of the three or four components: the single site catalyst, the alkylaluminoxane, the ionic activator, and the optional hindered phenol are optimized.

In an embodiment of the disclosure, the single site catalyst used to make the first ethylene copolymer produces no long chain branches, and/or the first ethylene copolymer will contain no measurable amounts of long chain branches.

In an embodiment of the disclosure, the single site catalyst used to make the first ethylene copolymer produces long chain branches, and the first ethylene copolymer will contain long chain branches, hereinafter ‘LCB’. LCB is a well-known structural phenomenon in ethylene copolymers and well known to those of ordinary skill in the art.

In an embodiment of the disclosure, the first ethylene copolymer has a density of from 0.855 to 0.965 g/cm³, a molecular weight distribution, M_{w}/Mₙ of from 1.7 to 2.3, and a melt index, I₂ of from 0.1 to 20 g/10 min.

In embodiments of the disclosure, the upper limit on the molecular weight distribution, M_{w}/Mₙ of the first ethylene copolymer may be about 2.8, or about 2.5, or about 2.4, or about 2.3, or about 2.2. In embodiments of the disclosure, the lower limit on the molecular weight distribution, M_{w}/Mₙ of the first ethylene copolymer may be about 1.6, or about 1.7, or about 1.8, or about 1.9.

In embodiments of the disclosure, the first ethylene copolymer has a molecular weight distribution, M_{W}/Mₙ of <2.3, or <2.3, or <2.1, or <2. 1, or <2.0, or ≤2.0, or about 2.0. In embodiments of the disclosure, the first ethylene copolymer has a molecular weight distribution, M_{w}/Mₙ of from about 1.7 to about 2.3, or from about 1.8 to about 2.3 or from about 1.8 to about 2.2.

The short chain branching (i.e. the short chain branching per thousand backbone carbon atoms, SCB1) is the branching due to the presence of an alpha-olefin comonomer in the ethylene copolymer and will for example have two carbon atoms for a 1-butene comonomer, or four carbon atoms for a 1-hexene comonomer, or six carbon atoms for a 1-octene comonomer, etc.

In an embodiment of the disclosure, the number of short chain branches per thousand carbon atoms in the first ethylene copolymer (SCB1), is greater than the number of short chain branches per thousand carbon atoms in the second ethylene copolymer (SCB2).

In an embodiment of the disclosure, the number of short chain branches per thousand carbon atoms in the first ethylene copolymer (SCB1), is about the same (i.e within about 5 percent, or without abut 10 percent) as the number of short chain branches per thousand carbon atoms in second ethylene copolymer (SCB2).

In an embodiment of the disclosure, the density of the first ethylene copolymer, d1 is equal to or less than the density of the second ethylene copolymer, d2.

In an embodiment of the disclosure, the density of the first ethylene copolymer, d1 is less than the density of the second ethylene copolymer, d2.

In embodiments of the disclosure, the upper limit on the CDBI₅₀ of the first ethylene copolymer may be about 98 wt %, in other cases about 95 wt % and in still other cases about 90 wt %. In embodiments of the disclosure, the lower limit on the CDBI₅₀ of the first ethylene copolymer may be about 70 wt %, in other cases about 75 wt % and in still other cases about 80 wt %.

In embodiments of the disclosure the melt index of the first ethylene copolymer 121 may be from about 0.01 dg/min to about 1,000 dg/min, including narrower ranges and specific values within this range.

In an embodiment of the disclosure, the first ethylene copolymer has a weight average molecular weight, M_{w} of from about 50,000 to about 300,000 g/mol including narrower ranges and specific values within this range.

In an embodiment of the disclosure, the first ethylene copolymer has a weight average molecular weight, M_{w} which is greater than the weight average molecular weight, M_{W} of the second ethylene copolymer.

In embodiments of the disclosure, the upper limit on the weight percent (wt %) of the first ethylene copolymer in the ethylene copolymer composition (i.e. the weight percent of the first ethylene copolymer based on the total weight of the first, the second and the optional third ethylene copolymer) may be about 80 wt %, or about 75 wt %, or about 70 wt %, or about 65 wt %, or about 60 wt %, or about 55 wt %, or about 50 wt %, or about 45 wt %, or about 40 wt %. In embodiments of the disclosure, the lower limit on the wt % of the first ethylene copolymer in the ethylene copolymer composition may be about 5 wt %, or about 10 wt %, or about 15 wt %, or about 20 wt %, or about 25 wt %, or about 30 wt %, or in other cases about 35 wt %.

### The Second Ethylene Copolymer

In an embodiment of the disclosure, the second ethylene copolymer is made with a multi-site catalyst, non-limiting examples of which include Ziegler-Natta catalysts and chromium catalysts, both of which are well known in the art.

In embodiments of the disclosure, alpha-olefins which may be copolymerized with ethylene to make the second ethylene copolymer may be selected from the group comprising 1-propene, 1-butene, 1-pentene, 1-hexene and 1-octene and mixtures thereof.

In an embodiment of the disclosure, the second ethylene copolymer is a heterogeneously branched ethylene copolymer.

In an embodiment of the disclosure, the second ethylene copolymer is an ethylene/1-octene copolymer.

In an embodiment of the disclosure, the second ethylene copolymer is made with a Ziegler-Natta catalyst.

Ziegler-Natta catalysts are well known to those skilled in the art. A Ziegler-Natta catalyst may be an in-line Ziegler-Natta catalyst system or a batch Ziegler-Natta catalyst system. The term “in-line Ziegler-Natta catalyst system” refers to the continuous synthesis of a small quantity of an active Ziegler-Natta catalyst system and immediately injecting this catalyst into at least one continuously operating reactor, wherein the catalyst polymerizes ethylene and one or more optional α-olefins to form an ethylene polymer. The terms “batch Ziegler-Natta catalyst system” or “batch Ziegler-Natta procatalyst” refer to the synthesis of a much larger quantity of catalyst or procatalyst in one or more mixing vessels that are external to, or isolated from, the continuously operating solution polymerization process. Once prepared, the batch Ziegler-Natta catalyst system, or batch Ziegler-Natta procatalyst, is transferred to a catalyst storage tank. The term “procatalyst” refers to an inactive catalyst system (inactive with respect to ethylene polymerization); the procatalyst is converted into an active catalyst by adding an alkyl aluminum co-catalyst. As needed, the procatalyst is pumped from the storage tank to at least one continuously operating reactor, wherein an active catalyst polymerizes ethylene and one or more optional α-olefins to form a ethylene copolymer. The procatalyst may be converted into an active catalyst in the reactor or external to the reactor, or on route to the reactor.

A wide variety of compounds can be used to synthesize an active Ziegler-Natta catalyst system. The following describes various compounds that may be combined to produce an active Ziegler-Natta catalyst system. Those skilled in the art will understand that the embodiments in this disclosure are not limited to the specific compounds disclosed.

An active Ziegler-Natta catalyst system may be formed from: a magnesium compound, a chloride compound, a metal compound, an alkyl aluminum co-catalyst and an aluminum alkyl. As will be appreciated by those skilled in the art, Ziegler-Natta catalyst systems may contain additional components; a non-limiting example of an additional component is an electron donor, e.g. amines or ethers.

A non-limiting example of an active in-line (or batch) Ziegler-Natta catalyst system can be prepared as follows. In the first step, a solution of a magnesium compound is reacted with a solution of a chloride compound to form a magnesium chloride support suspended in solution. Non-limiting examples of magnesium compounds include Mg(R¹)₂; wherein the R¹ groups may be the same or different, linear, branched or cyclic hydrocarbyl radicals containing 1 to 10 carbon atoms. Non-limiting examples of chloride compounds include R²Cl; wherein R² represents a hydrogen atom, or a linear, branched or cyclic hydrocarbyl radical containing 1 to 10 carbon atoms. In the first step, the solution of magnesium compound may also contain an aluminum alkyl. Non-limiting examples of aluminum alkyl include Al(R³)₃, wherein the R³ groups may be the same or different, linear, branched or cyclic hydrocarbyl radicals containing from 1 to 10 carbon atoms. In the second step a solution of the metal compound is added to the solution of magnesium chloride and the metal compound is supported on the magnesium chloride. Non-limiting examples of suitable metal compounds include M(X)ₙ or MO(X)ₙ; where M represents a metal selected from Group 4 through Group 8 of the Periodic Table, or mixtures of metals selected from Group 4 through Group 8; O represents oxygen; and X represents chloride or bromide; n is an integer from 3 to 6 that satisfies the oxidation state of the metal. Additional non-limiting examples of suitable metal compounds include Group 4 to Group 8 metal alkyls, metal alkoxides (which may be prepared by reacting a metal alkyl with an alcohol) and mixed-ligand metal compounds that contain a mixture of halide, alkyl and alkoxide ligands. In the third step a solution of an alkyl aluminum co-catalyst is added to the metal compound supported on the magnesium chloride. A wide variety of alkyl aluminum co-catalysts are suitable, as expressed by formula:

Al(R⁴)ₚ(OR⁹)_{q}(X)ᵣ

wherein the R⁴ groups may be the same or different, hydrocarbyl groups having from 1 to 10 carbon atoms; the OR⁹ groups may be the same or different, alkoxy or aryloxy groups wherein R⁹ is a hydrocarbyl group having from 1 to 10 carbon atoms bonded to oxygen; X is chloride or bromide; and (p+q+r)=3, with the proviso that p is greater than 0. Non-limiting examples of commonly used alkyl aluminum co-catalysts include trimethyl aluminum, triethyl aluminum, tributyl aluminum, dimethyl aluminum methoxide, diethyl aluminum ethoxide, dibutyl aluminum butoxide, dimethyl aluminum chloride or bromide, diethyl aluminum chloride or bromide, dibutyl aluminum chloride or bromide and ethyl aluminum dichloride or dibromide.

The process described in the paragraph above, to synthesize an active in-line (or batch) Ziegler-Natta catalyst system, can be carried out in a variety of solvents; non-limiting examples of solvents include linear or branched C₅ to C₁₂ alkanes or mixtures thereof.

In embodiments of the disclosure the melt index of the first ethylene copolymer I₂¹ may be from about 0.10 dg/min to about 20,000 dg/min, including narrower ranges and specific values within this range.

In an embodiment of the disclosure, the second ethylene copolymer has a density of from 0.875 to 0.965 g/cm³ including narrower ranges and specific values within this range.

In an embodiment of the disclosure, the second ethylene copolymer has a density of from 0.875 to 0.965 g/cm³; a molecular weight distribution, M_{w}/Mₙ of from 2.3 to 6.0; and a melt index, 1₂ of from 0.30 to 20,000 g/10 min.

In embodiments of the disclosure, the second ethylene copolymer has a molecular weight distribution, M_{W}/Mₙ of ≥2.3, or >2.3, or ≥2.5, or >2.5, or ≥2.7, or >2.7, or ≥2.9, or >2.9, or ≥3.0, or 3.0. In embodiments of the disclosure, the second ethylene copolymer has a molecular weight distribution, M_{w}/Mₙ of from 2.3 to 6.0, or from 2.3 to 5.5, or from 2.3 to 5.0, or from 2.3 to 4.5, or from 2.3 to 4.0, or from 2.3 to 3.5, or from 2.3 to 3.0, or from 2.5 to 5.0, or from 2.5 to 4.5, or from 2.5 to 4.0, or from 2.5 to 3.5, or from 2.7 to 5.0, or from 2.7 to 4.5, or from 2.7 to 4.0, or from 2.7 to 3.5, or from 2.9 to 5.0, or from 2.9 to 4.5, or from 2.9 to 4.0, or from 2.9 to 3.5.

In an embodiment of the disclosure, the density of the second ethylene copolymer, d2 is equal to or greater than the density of the first ethylene copolymer, d1.

In an embodiment of the disclosure, the density of the second ethylene copolymer, d2 is greater than the density of the first ethylene copolymer, d1.

In an embodiment of the disclosure, the second ethylene copolymer has a composition distribution breadth index, CDBI₅₀ of less than 75 wt % or 70 wt % or less. In further embodiments of the disclosure, the second ethylene copolymer has a CDBI₅₀ of 65 wt % or less, or 60 wt % or less, or 55 wt % or less, or 50 wt % or less, or 45 wt % or less.

In an embodiment of the disclosure, the second ethylene copolymer has a weight average molecular weight, M_{w} of from about 25,000 to about 250,000 g/mol, including narrower ranges and specific values within this range.

In an embodiment of the disclosure, the weight average molecular weight of the second ethylene copolymer is less than the weight average molecular weight of the first ethylene copolymer.

In embodiments of the disclosure, the upper limit on the weight percent (wt %) of the second ethylene copolymer in the ethylene copolymer composition (i.e. the weight percent of the second ethylene copolymer based on the total weight of the first, the second and the optional third ethylene copolymers) may be about 85 wt %, or about 80 wt %, or about 70 wt %, or about 65 wt %, in other cases about 60 wt %. In embodiments of the disclosure, the lower limit on the wt % of the second ethylene copolymer in the ethylene copolymer composition may be about 5 wt %, or about 10 wt %, or about 15 wt %, or about 20 wt %, or about 25 wt %, or about 30 wt %, or about 35 wt %, or about 40 wt %, or about 45 wt %, or in other cases about 50 wt %.

In embodiments of the disclosure, the second ethylene copolymer has no long chain branching present or does not have any detectable levels of long chain branching.

### The Optional Third Ethylene Copolymer

In an embodiment of the disclosure, ethylene copolymer composition comprises a third ethylene copolymer made in a third reactor.

In an embodiment, the third ethylene copolymer is made with a single site catalyst, non-limiting examples of which include phosphinimine catalysts, metallocene catalysts, and constrained geometry catalysts, all of which are well known in the art.

In an embodiment, a phosphinimine catalyst is used to make the third ethylene copolymer. Phosphinimine catalysts which can be used to make a third ethylene copolymer are as described above with regard to the phosphinimine catalyst which may be used to make the first ethylene copolymer.

In an embodiment, a metallocene catalyst is used to make the third ethylene copolymer. Metallocene catalysts which can be used to make a third ethylene copolymer are as described above with regard to the metallocene catalyst which may be used to make the first ethylene copolymer.

In an embodiment of the disclosure, the third ethylene copolymer is made with a multi-site catalyst, non-limiting examples of which include Ziegler-Natta catalysts and chromium catalysts, both of which are well known in the art.

In an embodiment, a Ziegler-Natta catalyst is used to make the third ethylene copolymer. Ziegler-Natta catalysts which can be used to make a third ethylene copolymer are as described above with regard to the Ziegler-Natta catalyst which may be used to make the second ethylene copolymer.

In embodiments of the disclosure, alpha-olefins which may be copolymerized with ethylene to make the third ethylene copolymer may be selected from the group comprising 1-propene, 1-butene, 1-pentene, 1-hexene and 1-octene and mixtures thereof.

In an embodiment of the disclosure, the third ethylene copolymer is a homogeneously branched ethylene copolymer.

In an embodiment of the disclosure, the third ethylene copolymer is an ethylene/1-octene copolymer.

In an embodiment of the disclosure, the third ethylene copolymer is made with a phosphinimine catalyst.

In an embodiment of the disclosure, the third ethylene copolymer is made with a metallocene catalyst.

In an embodiment of the disclosure, the third ethylene copolymer is made with a Ziegler-Natta catalyst.

In an embodiment of the disclosure, the third ethylene copolymer is a heterogeneously branched ethylene copolymer.

In embodiments of the disclosure, the upper limit on the molecular weight distribution, M_{w}/Mₙ of the third ethylene copolymer may be about 2.8, or about 2.5, or about 2.4, or about 2.3, or about 2.2. In embodiments of the disclosure, the lower limit on the molecular weight distribution, M_{w}/Mₙ of the third ethylene copolymer may be about 1.4, or about 1.6, or about 1.7, or about 1.8, or about 1.9.

In embodiments of the disclosure, the third ethylene copolymer has a molecular weight distribution, M_{W}/Mₙ of ≤2.3, or <2.3, or <2.1, or <2.1, or <2.0, or <2.0, or about 2.0. In embodiments of the disclosure, the first ethylene copolymer has a molecular weight distribution, M_{w}/Mₙ of from about 1.7 to about 2.3, or from about 1.8 to about 2.3, or from about 1.8 to 2.2.

In embodiments of the disclosure, the third ethylene copolymer has a molecular weight distribution, M_{w}/Mₙ of ≥2.3, or >2.3, or ≥2.5, or >2.5, or ≥2.7, or >2.7, or ≥2.9, or >2.9, or ≥3.0, or 3.0. In embodiments of the disclosure, the third ethylene copolymer has a molecular weight distribution, M_{w}/Mₙ of from 2.3 to 6.5, or from 2.3 to 6.0, or from 2.3 to 5.5, or from 2.3 to 5.0, or from 2.3 to 4.5, or from 2.3 to 4.0, or from 2.3 to 3.5, or from 2.3 to 3.0, or from 2.5 to 5.0, or from 2.5 to 4.5, or from 2.5 to 4.0, or from 2.5 to 3.5, or from 2.7 to 5.0, or from 2.7 to 4.5, or from 2.7 to 4.0, or from 2.7 to 3.5, or from 2.9 to 5.0, or from 2.9 to 4.5, or from 2.9 to 4.0, or from 2.9 to 3.5.

In embodiments of the disclosure, the third ethylene copolymer has a molecular weight distribution, M_{W}/Mₙ of from 2.0 to 6.5, or from 2.3 to 6.5, or from 2.3 to 6.0, or from 2.0 to 6.0.

In embodiments of the disclosure the density, d3 of the third ethylene copolymer may be from about 0.865 g/cm³ to about 0.965 g/cm³, including narrower ranges and specific values within this range.

In embodiments of the disclosure, the upper limit on the CDBI₅₀ of the third ethylene copolymer may be about 98 wt %, in other cases about 95 wt % and in still other cases about 90 wt %. In embodiments of the disclosure, the lower limit on the CDBI₅₀ of the third ethylene copolymer may be about 70 wt %, in other cases about 75 wt % and in still other cases about 80 wt %.

In an embodiment of the disclosure, the third ethylene copolymer has a composition distribution breadth index, CDBI₅₀ of less than 75 wt %, or 70 wt % or less. In further embodiments of the disclosure, the third ethylene copolymer has a CDBI₅₀ of 65 wt % or less, or 60 wt % or less, or 55 wt % or less, or 50 wt % or less, or 45 wt % or less.

In embodiments of the disclosure the melt index of the third ethylene copolymer I₂₃ may be from about 0.01 dg/min to about 10,000 dg/min, including narrower ranges and specific values within this range.

In an embodiment of the disclosure, the third ethylene copolymer has a weight average molecular weight, M_{w} of from about 50,000 to about 300,000 including narrower ranges and specific values within this range.

In embodiments of the disclosure, the upper limit on the weight percent (wt %) of the third ethylene copolymer in the ethylene copolymer composition (i.e. the weight percent of the third ethylene copolymer based on the total weight of the first, the second and the third ethylene copolymer) may be about 60 wt %, or about 55 wt %, or 50 wt %, in other cases about 45 wt %, in other cases about 40 wt %, or about 35 wt %, or about 30 wt %, or about 25 wt %, or about 20 wt %. In embodiments of the disclosure, the lower limit on the wt % of the third ethylene copolymer in the ethylene copolymer composition may be 0 wt %, or about 1 wt %, or about 3 wt %, or about 5 wt %, or about 10 wt %, or about 15 wt %.

### The Ethylene Copolymer Composition

In embodiments of the disclosure, the ethylene copolymer composition has at least 0.5 mole percent, or at least 1 mole percent or at least 3 mol percent, or at least 5 mole percent of one or more than one alpha olefin.

In embodiments of the disclosure, the ethylene copolymer composition has from about 1 to about 20 mole percent, or from about 1 to about 15 mole percent, or from about 1 to about 8 mole percent, or from about 3 to about 20 mole percent, or from about 3 to about 15 mole percent, or from about 3 to about 10 mole percent, or from about 3 to about 8 mole percent of one or more than one alpha-olefin.

In an embodiment of the disclosure, the ethylene copolymer composition comprises ethylene and one or more than one alpha olefin selected from the group comprising 1-butene, 1-hexene, 1-octene and mixtures thereof.

In an embodiment of the disclosure, the ethylene copolymer composition comprises ethylene and one or more than one alpha olefin selected from the group comprising 1-hexene, 1-octene and mixtures thereof.

In an embodiment of the disclosure, the ethylene copolymer composition comprises ethylene and 1-octene.

In embodiments of the disclosure, the ethylene copolymer composition comprises ethylene and from about 1 to about 20 mole percent, or from about 1 to about 15 mole percent, or from about 1 to about 8 mole percent, or from about 3 to about 20 mole percent, or from about 3 to about 15 mole percent, or from about 3 to about 10 mole percent, or from about 3 to about 8 mole percent of 1-octene.

In embodiments of the disclosure, the ethylene copolymer composition has a density which may be from about 0.855 g/cm³ to about 0.965 g/cm³, including narrower ranges and specific values within this range.

In embodiments of the disclosure, the ethylene copolymer composition has a density which may be from about 0.912 g/cm³ to about 0.940 g/cm³, including narrower ranges and specific values within this range. In embodiments of the disclosure, the ethylene copolymer composition has a density which may be from about 0.912 g/cm³ to about 0.939 g/cm³, or from about 0.914 g/cm³ to about 0.939 g/cm³, or from about 0.916 g/cm³ to about 0.939 g/cm³, or from about 0.918 g/cm³ to about 0.939 g/cm³, or from about 0.921 g/cm³ to about 0.940 g/cm³.

In embodiments of the disclosure the melt index, I₂ of the ethylene copolymer composition may be from about 0.01 dg/min to about 20.0 dg/min including narrower ranges and specific values within this range.

In embodiments of the disclosure the melt index, I₂ of the ethylene copolymer composition may be from about 0.01 dg/min to about 10.0 dg/min including narrower ranges and specific values within this range.

In embodiments of the disclosure the melt index, I₂ of the ethylene copolymer composition may be from about 0.1 dg/min to about 10.0 dg/min including narrower ranges and specific values within this range. In embodiments of the disclosure the melt index, I₂ of the ethylene copolymer composition may be from about 0.1 dg/min to about 7.5 dg/min, or from about 0.1 dg/min to about 5.0 dg/min, or from about 0.1 dg/min to about 2.5 dg/min, or from about 0.1 to 1.5 dg/min, or from about 0.5 dg/min to about 10.0 dg/min, or from about 0.5 dg/min to about 7.5 dg/min, or from about 0.5 dg/min to about 5.0 dg/min, or from about 0.5 dg/min to about 2.5 dg/min, or from about 0.5 dg/min to about 1.5 dg/min.

In embodiments of the disclosure, the ethylene copolymer composition has a weight average molecular weight, M_{w} of from about 40,000 to about 300,000 g/mol including narrower ranges and specific values within this range.

In embodiments of the disclosure, the ethylene copolymer composition has a lower limit molecular weight distribution, M_{w}/Mₙ of 2.0, or 2.1, or 2.2, or 2.3. In embodiments of the disclosure, the polyethylene composition has an upper limit molecular weight distribution, M_{w}/Mₙ of 6.0, or 5.5, or 5.0, or 4.5, or 4.0, or 3.75, or 3.5.

In embodiments of the disclosure, the ethylene copolymer composition has a molecular weight distribution, M_{w}/Mₙ of from 2.1 to 6.0, or from 2.1 to 5.5, or from 2.1 to 5.0, or from 2.1 to 4.5, or from 2.1 to 4.0, or from 2.1 to 3.5, or from 2.1 to 3.0, or from 2.2 to 5.5, or from 2.2 to 5.0, or from 2.2 to 4.5, or from 2.2 to 4.0, or from 2.2 to 3.5, or from 2.2 to 3.0.

In embodiments of the disclosure, the ethylene copolymer composition has a Z-average molecular weight distribution, M_{z}/M_{w} of ≤4.0, or ≤4.0, or ≤3.5, or <3.5, or ≤3.0, or <3.0, or ≤2.75, or ≤2.75, or ≤2.50, or <2.50. In embodiments of the disclosure, the polyethylene composition has a Z-average molecular weight distribution, M_{z}/M_{w} of from 1.5 to 4.0, or from 1.75 to 3.5, or from 1.75 to 3.0, or from 2.0 to 4.0, or from 2.0 to 3.5, or from 2.0 to 3.0, or from 2.0 to 2.75.

In an embodiment of the disclosure, the ethylene copolymer composition has a unimodal profile in a gel permeation chromatograph generated according to the method of ASTM D6474-99.

In an embodiment of the disclosure, the ethylene copolymer composition has a bimodal profile in a gel permeation chromatograph generated according to the method of ASTM D6474-99.

In an embodiment of the disclosure, the ethylene copolymer composition has a multimodal profile in a gel permeation chromatograph generated according to the method of ASTM D6474-99.

The term “unimodal” is herein defined to mean there will be only one significant peak or maximum evident in the GPC-curve. A unimodal profile includes a broad unimodal profile. In contrast, the use of the term “bimodal” is meant to convey that in addition to a first peak, there will be a secondary peak or shoulder which represents a higher or lower molecular weight component (i.e. the molecular weight distribution, can be said to have two maxima in a molecular weight distribution curve). Alternatively, the term “bimodal” connotes the presence of two maxima in a molecular weight distribution curve generated according to the method of ASTM D6474-99. The term “multi-modal” denotes the presence of two or more, typically more than two, maxima in a molecular weight distribution curve generated according to the method of ASTM D6474-99.

In an embodiment of the disclosure, the ethylene copolymer composition will have a reverse or partially reverse comonomer distribution profile as measured using GPC-FTIR.

In an embodiment of the disclosure, the ethylene copolymer composition will have a normal comonomer distribution profile as measured using GPC-FTIR.

In an embodiment of the disclosure, the ethylene copolymer composition will have a substantially flat comonomer distribution profile as measured using GPC-FTIR.

If the comonomer incorporation decreases with molecular weight, as measured using GPC-FTIR, the distribution is described as “normal”. If the comonomer incorporation is approximately constant with molecular weight, as measured using GPC-FTIR, the comonomer distribution is described as “flat” or “uniform”. The terms “reverse comonomer distribution” and “partially reverse comonomer distribution” mean that in the GPC-FTIR data obtained for a copolymer, there is one or more higher molecular weight components having a higher comonomer incorporation than in one or more lower molecular weight components. The term “reverse(d) comonomer distribution” is used herein to mean, that across the molecular weight range of an ethylene copolymer, comonomer contents for the various polymer fractions are not substantially uniform and the higher molecular weight fractions thereof have proportionally higher comonomer contents (i.e. if the comonomer incorporation rises with molecular weight, the distribution is described as “reverse” or “reversed”). Where the comonomer incorporation rises with increasing molecular weight and then declines, the comonomer distribution is still considered “reverse”, but may also be described as “partially reverse”. A partially reverse comonomer distribution will exhibit a peak or maximum.

In embodiments of the disclosure, the ethylene copolymer composition has a CDBI₅₀ of from about 15 to 85 weight %, including narrower ranges and specific values within this range.

The following examples are presented for the purpose of illustrating selected embodiments of this disclosure; it being understood, that the examples presented do not limit the claims presented.

### EXAMPLES

### General Testing Procedures

Prior to testing, each polymer specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Ethylene copolymer composition densities were determined using ASTM D792-13 (Nov. 1, 2013).

### Melt Index

Ethylene copolymer composition melt index was determined using ASTM D1238 (Aug. 1, 2013). Melt indexes, I₂, I₆, I₁₀ and I₂₁ were measured at 190° C., using weights of 2.16 kg, 6.48 kg, 10 kg and a 21.6 kg respectively. Herein, the term “stress exponent” or its acronym “S.Ex.”, is defined by the following relationship: S.Ex.=log (I₆/I₂)/log(6480/2160) wherein 16 and I₂ are the melt flow rates measured at 190° C. using 6.48 kg and 2.16 kg loads, respectively.

### Conventional Size Exclusion Chromatography (SEC)

Ethylene copolymer composition samples (polymer) solutions (1 to 3 mg/mL) were prepared by heating the polymer in 1,2,4-trichlorobenzene (TCB) and rotating on a wheel for 4 hours at 150° C. in an oven. An antioxidant (2,6-di-tert-butyl-4-methylphenol (BHT)) was added to the mixture in order to stabilize the polymer against oxidative degradation. The BHT concentration was 250 ppm. Polymer solutions were chromatographed at 140° C. on a PL 220 high-temperature chromatography unit equipped with four SHODEX® columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect GPC columns from oxidative degradation. The sample injection volume was 200 μL. The GPC columns were calibrated with narrow distribution polystyrene standards. The polystyrene molecular weights were converted to polyethylene molecular weights using the Mark-Houwink equation, as described in the ASTM standard test method D6474-12 (December 2012). The GPC raw data were processed with the CIRRUS® GPC software, to produce molar mass averages (Mₙ, M_{w}, M_{z}) and molar mass distribution (e.g. Polydispersity, M_{w}/Mₙ). In the polyethylene art, a commonly used term that is equivalent to SEC is GPC, i.e. Gel Permeation Chromatography.

### GPC-FTIR

Ethylene copolymer composition (polymer) solutions (2 to 4 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a Waters GPC 150C chromatography unit equipped with four SHODEX columns (HT803, HT804, HT805 and HT806) using TCB as the mobile phase with a flow rate of 1.0 mL/minute, with a FTIR spectrometer and a heated FTIR flow through cell coupled with the chromatography unit through a heated transfer line as the detection system. BHT was added to the mobile phase at a concentration of 250 ppm to protect SEC columns from oxidative degradation. The sample injection volume was 300 μL. The raw FTIR spectra were processed with OPUS® FTIR software and the polymer concentration and methyl content were calculated in real time with the Chemometric Software (PLS technique) associated with the OPUS. Then the polymer concentration and methyl content were acquired and baseline-corrected with the CIRRUS GPC software. The SEC columns were calibrated with narrow distribution polystyrene standards. The polystyrene molecular weights were converted to polyethylene molecular weights using the Mark-Houwink equation, as described in the ASTM standard test method D6474. The comonomer content was calculated based on the polymer concentration and methyl content predicted by the PLS technique as described in Paul J. DesLauriers, Polymer 43, pages 159-170 (2002); herein incorporated by reference.

The GPC-FTIR method measures total methyl content, which includes the methyl groups located at the ends of each macromolecular chain, i.e. methyl end groups. Thus, the raw GPC-FTIR data must be corrected by subtracting the contribution from methyl end groups. To be more clear, the raw GPC-FTIR data overestimates the amount of short chain branching (SCB) and this overestimation increases as molecular weight (M) decreases. In this disclosure, raw GPC-FTIR data was corrected using the 2-methyl correction. At a given molecular weight (M), the number of methyl end groups (N_{E}) was calculated using the following equation: N_{E}=28000/M, and N_{E} (M dependent) was subtracted from the raw GPC-FTIR data to produce the SCB/1000C (2-Methyl Corrected) GPC-FTIR data.

### CRYSTAF/TREF (CTEF)

The “Composition Distribution Breadth Index”, hereinafter CDBI, of the ethylene copolymer compositions (and Comparative Examples) was measured using a CRYSTAF/TREF 200+ unit equipped with an IR detector, hereinafter the CTREF. The acronym “TREF” refers to Temperature Rising Elution Fractionation. The CTREF was supplied by Polymer Char S. A. (Valencia Technology Park, Gustave Eiffel, 8, Paterna, E-46980 Valencia, Spain). The CTREF was operated in the TREF mode, which generates the chemical composition of the polymer sample as a function of elution temperature, the Co/Ho ratio (Copolymer/Homopolymer ratio) and the CDBI (the Composition Distribution Breadth Index), i.e. CDBI₅₀ and CDBI₂₅. A polymer sample (80 to 100 mg) was placed into the reactor vessel of the CTREF. The reactor vessel was filled with 35 ml of 1,2,4-trichlorobenzene (TCB) and the polymer was dissolved by heating the solution to 150° C. for 2 hours. An aliquot (1.5 mL) of the solution was then loaded into the CTREF column which was packed with stainless steel beads. The column, loaded with sample, was allowed to stabilize at 110° C. for 45 minutes. The polymer was then crystallized from solution, within the column, by dropping the temperature to 30° C. at a cooling rate of 0.09° C./minute. The column was then equilibrated for 30 minutes at 30° C. The crystallized polymer was then eluted from the column with TCB flowing through the column at 0.75 mL/minute, while the column was slowly heated from 30° C. to 120° C. at a heating rate of 0.25° C./minute. The raw CTREF data were processed using Polymer Char software, an Excel spreadsheet and CTREF software developed in-house. CDBI₅₀ was defined as the percent of polymer whose composition is within 50% of the median comonomer composition; CDBI₅₀ was calculated from the composition distribution cure and the normalized cumulative integral of the composition distribution curve, as described in U.S. Pat. No. 5,376,439. Those skilled in the art will understand that a calibration curve is required to convert a CTREF elution temperature to comonomer content, i.e. the amount of comonomer in the ethylene/α-olefin polymer fraction that elutes at a specific temperature. The generation of such calibration curves are described in the prior art, e.g. Wild, et al., J. Polym. Sci., Part B, Polym. Phys., Vol. 20 (3), pages 441-455: hereby fully incorporated by reference. CDBI₂₅ as calculated in a similar manner; CDBI₂₅ is defined as the percent of polymer whose composition is with 25% of the median comonomer composition. At the end of each sample run, the CTREF column was cleaned for 30 minutes; specifically, with the CTREF column temperature at 160° C., TCB flowed (0.5 mL/minute) through the column for 30 minutes.

The CTREF procedures described above are also used to determine the modality of a TREF profile, the temperatures or temperatures ranges where elution intensity maxima (elution peaks) occur, the Co/Ho ratio Copolymer/Homopolymer ratio) and the weight percent (wt %) of the ethylene copolymer composition which elutes at a temperature of from 90° C. to 105° C. (i.e. the intergrated area of the fraction, in weight percent, of the ehtylene copolymer composition which elutes at from 90° C. to 105° C. in a CTREF analysis; this is also called the “HD fraction”, or the “high density fraction”).

### Unsaturation

The quantity of unsaturated groups, i.e. double bonds, in an ethylene copolymer composition was determined according to ASTM D3124-98 (vinylidene unsaturation, published March 2011) and ASTM D6248-98 (vinyl and trans unsaturation, published July 2012). An ethylene copolymer composition sample was: a) first subjected to a carbon disulfide extraction to remove additives that may interfere with the analysis; b) the sample (pellet, film or granular form) was pressed into a plaque of uniform thickness (0.5 mm); and c) the plaque was analyzed by FTIR.

### Comonomer Content: Fourier Transform Infrared (FTIR) Spectroscopy

The quantity of comonomer in an ethylene copolymer composition was determined by FTIR and reported as the Short Chain Branching (SCB) content having dimensions of CH₃#/1000C (number of methyl branches per 1000 carbon atoms). This test was completed according to ASTM D6645-01 (2001), employing a compression molded polymer plaque and a Thermo-Nicolet 750 Magna-IR Spectrophotometer. The polymer plaque was prepared using a compression molding device (Wabash-Genesis Series press) according to ASTM D4703-16 (April 2016).

### Differential Scanning Calorimetry (DSC)

Primary melting peak (° C.), melting peak temperatures (° C.), heat of fusion (J/g) and crystallinity (%) was determined using differential scanning calorimetry (DSC) as follows: the instrument was first calibrated with indium; after the calibration, a polymer specimen is equilibrated at 0° C. and then the temperature was increased to 200° C. at a heating rate of 10° C./min; the melt was then kept isothermally at 200° C. for five minutes; the melt was then cooled to 0° C. at a cooling rate of 10° C./min and kept at 0° C. for five minutes; the specimen was then heated to 200° C. at a heating rate of 10° C./min. The DSC Tm, heat of fusion and crystallinity are reported from the 2^{nd} heating cycle.

### Melt Strength

The melt strength is measured on Rosand RH-7 capillary rheometer (barrel diameter=15 mm) with a flat die of 2-mm Diameter, L/D ratio 10:1 at 190° C. Pressure Transducer: 10,000 psi (68.95 MPa). Piston Speed: 5.33 mm/min. Haul-off Angle: 52°. Haul-off incremental speed: 50-80 m/min² or 65±15 m/min². A polymer melt is extruded through a capillary die under a constant rate and then the polymer strand is drawn at an increasing haul-off speed until it ruptures. The maximum steady value of the force in the plateau region of a force versus time curve is defined as the melt strength for the polymer. The melt strength stretch ratio is defined as the ratio of the velocity at pulley over the velocity at the exit of the die.

### Vicat Softening Point (Temperature)

The Vicat softening point of an ethylene copolymer composition was determined according to ASTM D1525-07 (published December 2009). This test determines the temperature at which a specified needle penetration occurs when samples are subjected to ASTM D1525-07 test conditions, i.e., heating Rate B (120±10° C./hr and 938 gram load (10±0.2N load).

### Optical Properties

To assess the optical performance of the ethylene copolymer compositions, film samples were made (using the conditions discussed below under “Solution Polymerization in Dual Reactor Polymerization Process, The Method”) and assessed according to: Haze, ASTM D1003-13 (Nov. 15, 2013); and Gloss at 450 ASTM D2457-13 (Apr. 1, 2013).

### Solution Polymerization in Dual Reactor Polymerization Process, the Method

Ethylene copolymer compositions were each made using a mixed dual catalyst system in an “in-series” dual reactor solution polymerization process. As a result, ethylene copolymer compositions each comprised a first ethylene copolymer made with a single site catalyst and a second ethylene copolymer made with a multi-site catalyst. An “in series” dual reactor, solution phase polymerization process, including one employing a mixed dual catalyst has been described in U.S. Pat. Appl. Pub. No. 2016/0108218. Basically, in an “in-series” dual reactor system the exit stream from a first polymerization reactor (R1) flows directly into a second polymerization reactor (R2). The R1 pressure was from about 14 MPa to about 18 MPa; while R2 was operated at a lower pressure to facilitate continuous flow from R1 to R2. Both R1 and R2 were continuously stirred reactors (CSTR's) and were agitated to give conditions in which the reactor contents were well mixed. The process was operated continuously by feeding fresh process solvent, ethylene, 1-octene and hydrogen to the reactors and in the removal of product. Methylpentane was used as the process solvent (a commercial blend of methylpentane isomers). The volume of the first CSTR reactor (R1) was 3.2 gallons (12 L), and the volume of the second CSTR reactor (R2) was 5.8 gallons (22 L). Monomer (ethylene) and comonomer (1-octene) were purified prior to addition to the reactor using conventional feed preparation systems (such as contact with various absorption media to remove impurities such as water, oxygen and polar contaminants). The reactor feeds were pumped to the reactors at the ratios shown in Tables 1A-E. the residence time is defined as the average time the catalyst, solvent, monomer and comonomer spend in a polymerization reactor.

The average residence time is determined by taking the reactor volume and dividing by the total volumetric feed per unit of time (derivable from the total solution rate, the TSR, which is the total flow in kg/hour) to the reactor. In practice, the actual residence time is a distribution centered around the average residence time. The average reactor residence time may vary widely depending on process flow rates; whereas, the distribution of residence times can change with reactor mixing and reactor design. The “TSR” is the total solution rate in kg/hour. The TSR is the sum (kg) of all flows to the reactor (e.g. solvent, monomer, comonomer and catalyst components) per hour.

The ethylene conversion (which is the amount of ethylene consumed as a percentage of the amount fed to a reactor) was determined by a dedicated on-line gas chromatograph.

The following single site catalyst (SSC) components were used to prepare the first ethylene copolymer in a first reactor (R1) configured in series to a second reactor (R2): cyclopentadienyl tri(tertiarybutyl)phosphinimine titanium dichloride [Cp((t-Bu)₃PN)TiCl₂]; methylaluminoxane (MMAO-07); trityl tetrakis(pentafluoro-phenyl)borate (trityl borate); and 2,6-di-tert-butyl-4-ethylphenol (BHEB). Methylaluminoxane (MMAO-07) and 2,6-di-tert-butyl-4-ethylphenol are premixed in-line and then combined with cyclopentadienyl tri(tertiarybutyl)phosphinimine titanium dichloride [Cp((t-Bu)₃PN)TiCl₂] and trityl tetrakis(pentafluoro-phenyl)borate just before entering the polymerization reactor (R1). The quantity of Cp((t-Bu)₃PN)TiCl₂ added to the reactor is shown in Tables 1A-1E. The efficiency of the single site catalyst formulation was optimized by adjusting the mole ratios of the catalyst components and the R1 catalyst inlet temperature (See Tables 1A-1E).

The following Ziegler-Natta (ZN) catalyst components were used to prepare the second ethylene copolymer in a second reactor (R2) configured in series to a first reactor (R1): butyl ethyl magnesium; tertiary butyl chloride; titanium tetrachloride; diethyl aluminum ethoxide; and triethyl aluminum. Methylpentane was used as the catalyst component solvent and the in-line Ziegler-Natta catalyst formulation was prepared using the following steps and then injected into the second reactor (R2). In step one, a solution of triethylaluminum and butyl ethyl magnesium (Mg:Al=20, mol:mol) was combined with a solution of tertiary butyl chloride and allowed to react for about 30 seconds to produce a MgCl₂ support. In step two, a solution of titanium tetrachloride was added to the mixture formed in step one and allowed to react for about 14 seconds prior to injection into second reactor (R2). The in-line Ziegler-Natta catalyst was activated in the reactor by injecting a solution of diethyl aluminum ethoxide into R2. The quantity of titanium tetrachloride added to the reactor is shown in Tables 1A-1E. The efficiency of the in-line Ziegler-Natta catalyst formulation was optimized by adjusting the mole ratios of the catalyst components (See Tables 1A-1E).

Polymerization in the continuous solution polymerization process was terminated by adding a catalyst deactivator to the second reactor exit stream. The catalyst deactivator used was octanoic acid (caprylic acid), commercially available from P&G Chemicals, Cincinnati, OH, U.S.A. The catalyst deactivator was added such that the moles of fatty acid added were 50% of the total molar amount of hafnium, titanium and aluminum added to the polymerization process; to be clear, the moles of octanoic acid added=0.5×(moles hafnium+moles titanium+moles aluminum).

A two-stage devolatilization process was employed to recover the ethylene copolymer composition from the process solvent, i.e. two vapor/liquid separators were used and the second bottom stream (from the second V/L separator) was passed through a gear pump/pelletizer combination. DHT-4V (hydrotalcite), supplied by Kyowa Chemical Industry Co. Ltd., Tokyo, Japan was used as a passivator, or acid scavenger, in the continuous solution process. A slurry of DHT-4V in process solvent was added prior to the first V/L separator. The molar amount of DHT-4V added was 10-fold higher than the molar amount of tertiary butyl chloride and titanium tetrachloride added to the solution process.

Prior to pelletization the ethylene copolymer composition was stabilized by adding 500 ppm of IRGANOX® 1076 (a primary antioxidant) and 500 ppm of IRGAFOS® 168 (a secondary antioxidant), based on weight of the ethylene copolymer composition. Antioxidants were dissolved in process solvent and added between the first and second V/L separators.

In order to assess their optical performance properties, the ethylene copolymer compositions were blown into monolayer film having a target thickness of about 1 mil. The ethylene copolymer compositions were blown into monolayer film using a Gloucester Blown Film Line, with a single screw extruder, having 2.5-inch (6.45 cm) barrel diameter, 24/1 L/D (barrel Length/barrel Diameter) equipped with: a barrier screw; a low pressure 4 inch (10.16 cm) diameter die with a 35 mil (0.089 cm) die gap, and; a Western Polymer Air ring. The die was coated with polymer processing aid (PPA) by spiking the line with a high concentration of PPA masterbatch to avoid melt fracture. The extruder was equipped with the following screen pack: 20/40/60/80/20 mesh. Blown films, of about 1.0 mil (25.4 m) thick, at 2.5:1 blow up ratio (BUR), were produced at a constant output rate of 100 lb/hr (45.4 kg/hr) by adjusting extruder screw speed; and the frost line height was maintained at 16-18 inch (40.64-45.72 cm) by adjusting the cooling air. The monolayer 1-mil films produced with a blow-up ratio (BUR) of 2.5 were used for assessing haze and gloss values.

Tables 1A-1E shows the reactor conditions used to make each of the ethylene copolymer compositions. Tables 1A-1E include process parameters, such as alpha-olefin ratio split (which in the present examples is the 1-octene ratio split), the ethylene splits between the reactors (R1 and R2), the reactor temperatures, the ethylene conversions, etc.

The properties of the ethylene copolymer compositions are shown in Tables 2A-2E along with the optical properties of monolayer blown film having a thickness of about 1 mil and which was prepared from the ethylene copolymer compositions.

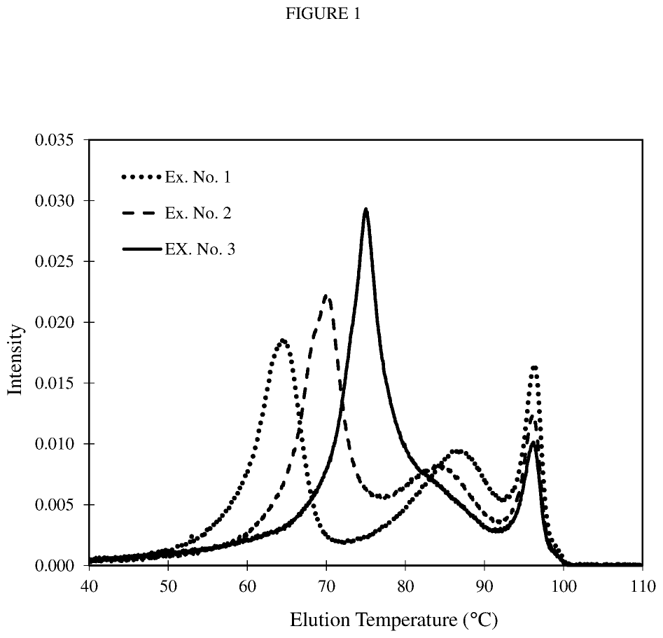

Finally, the CTREF profile for several of the ethylene copolymer compositions is shown in FIGS. 1-5.

TABLE 1A
Reactor Operating Conditions (Targeting an Ethylene
Copolymer Composition Having a Density of 0.919 g/cm³ and
a Melt Index, I₂ of 0.85 g/10 min)

| | Example No. | | |
|---|---|---|---|
| | 1 | 2 | 3 |
| Total Solution Rate (TSR) (kg/h) | 548.8 | 548.4 | 550.0 |
| Ethylene Concentration (wt % overall) | 15.0 | 15.1 | 15.1 |
| Ethylene Split Between Reactors | 45.0 | 45.0 | 45.0 |
| (R1/(R1 + R2)^{NOTE 1} | | | |
| 1-Octene/ethylene (wt %) (total)^{NOTE 2} | 0.330 | 0.450 | 0.530 |
| 1-Octene Split Between Reactors | 0.54 | 0.31 | 0.22 |
| (R1/(R1 + R2))^{NOTE 3} | | | |
| 1-Octene Ratio Split Between Reactors | 0.59 | 0.35 | 0.26 |
| (R1/(R1 + R2))^{NOTE 4} | | | |
| Polymer Production Rate in kg/h | 85.1 | 85.0 | 85.1 |
| (by near infra-red) | | | |
| Reactor 1 (R1) | | | |
| Total Solution Rate in R1 (kg/h) | 283.4 | 278.9 | 271.8 |
| Ethylene Concentration (wt %) in R1 | 13.10 | 13.40 | 13.75 |
| 1-Octene/ethylene in Fresh Feed (g/g) | 0.43 | 0.34 | 0.28 |
| Primary Feed Inlet Temperature | 25.0 | 25.0 | 25.0 |
| in R1 (° C.) | | | |
| R1 Control temperature (° C.) | 167.4 | 167.3 | 170.1 |
| Ethylene Conversion, | 78 | 78 | 78 |
| by near infra-red, in R1 (%) | | | |
| Hydrogen Feed (ppm) | 3.50 | 3.50 | 3.50 |
| Single Site Catalyst (ppm) to R1 | 0.52 | 0.43 | 0.41 |
| SSC - Al/Ti (mol/mol) | 60.0 | 60.1 | 60.3 |
| SSC - BHEB/Al (mol/mol) | 0.20 | 0.20 | 0.20 |
| SSC - B/Ti (mol/mol) | 1.30 | 1.30 | 1.31 |
| R1 Diluent Temperature (° C.) | 20.5 | 19.6 | 19.9 |
| Reactor 2 (R2) | | | |
| Total Solution Rate in R2 (kg/h) | 265.4 | 269.5 | 278.2 |
| Ethylene Fresh Feed to | 17.1 | 16.9 | 16.4 |
| R2 concentration (wt %) | | | |
| 1-Octene/ethylene in fresh feed (g/g) | 0.30 | 0.62 | 0.82 |
| Primary Feed Temperature in R2 (° C.) | 40.0 | 40.0 | 40.0 |
| R2 Control Temperature (° C.) | 206.4 | 205.0 | 204.9 |
| Ethylene Conversion, | 80 | 78 | 78 |
| by near infra-red, in R2 (%) | | | |
| Hydrogen Feed (ppm) | 3.86 | 6.85 | 9.79 |
| Multi-Site Catalyst (Titanium | 5.29 | 5.17 | 5.35 |
| tetrachloride, TiCl₄ in ppm) to R2 | | | |
| ZN - tert-tert-Butyl chloride/ | 1.92 | 1.92 | 1.92 |
| Butyl(ethyl)magnesium in R2 (mol/mol) | | | |
| ZN - Diethylaluminium ethoxide/TiCl₄ | 1.35 | 1.35 | 1.35 |
| in R2 (mol/mol) | | | |
| ZN - Triethylaluminium/TiCl₄ | 0.37 | 0.37 | 0.37 |
| in R2 (mol/mol) | | | |
| ZN - Butyl(ethyl)magnesium/TiCl₄ | 6.9 | 6.8 | 7.0 |
| in R2 (mol/mol) | | | |
| R2 Diluent Temperature (° C.) | 30.0 | 29.9 | 29.9 |

^{NOTE 1}Ethylene Split Between Reactors (R1/(R1 + R2) = (F1_{ethylene}/FT_{ethylene}) * 100; where F1_{ethylene} is the flow rate (in kg/hour) of ethylene to the first reactor; and FT_{ethylene} is the total ethylene flow (in kg/hour) to both reactors 1 and 2.
^{NOTE 2}1-Octene/ethylene (wt %) (total) = (F1_{1-octene} + F2_{1-octene})/(F1_{ethylene} + F2_{ethylene}); where F1_{1-octene} is the flow rate (in kg/hour) of 1-octene to the first reactor; F2_{1-octene} is the flow rate (in kg/hour) of 1-octene to the second reactor; F1_{ethylene} is the flow rate (in kg/hour) of ethylene to the first reactor; and F2_{ethylene} is the flow rate (in kg/hour) of ethylene to the second reactor.
^{NOTE 3}1-Octene Split Between Reactors (R1/(R1 + R2)) = (F1_{1-octene}/FT_{1-octene}) * 100; wherein F1_{1-octene} is the flow rate (in kg/hour) of 1-octene to the first reactor; and FT_{1-octene} is the total 1-octene flow (in kg/hour) to both reactors 1 and 2.
^{NOTE 4}1-Octene Ratio Split Between Reactors (R1/(R1 + R2)) = F1_{1-octene} × F2_{ethylene}/(F1_{1-octene} × F2_{ethylene} + F2_{1-octene} × F1_{ethylene}); where F1_{1-octene} is the flow rate (in kg/hour) of 1-octene to the first reactor; F1_{ethylene} is the flow rate (in kg/hour) of ethylene to the first reactor; F2_{1-octene} is the flow rate (in kg/hour) of 1-octene to the second reactor; and F2_{ethylene} is the flow rate (in kg/hour) of ethylene to the second reactor.

TABLE 2A
Polymer Properties and Blown Film Optical Properties

| | Example No. | | |
|---|---|---|---|
| | 1 | 2 | 3 |
| Density (g/cm³) | 0.9192 | 0.9186 | 0.9192 |
| Melt Index I₂ (g/10 min) | 0.87 | 0.84 | 0.88 |
| Melt Index I₆ (g/10 min) | 3.99 | 3.84 | 4.13 |
| Melt Index I₁₀ (g/10 min) | 7.55 | 7.28 | 7.69 |
| Melt Index I₂₁ (g/10 min) | 27.03 | 25.83 | 28.62 |
| Melt Flow Ratio (I₂₁/I₂) | 31.06 | 30.93 | 32.52 |
| Stress Exponent | 1.39 | 1.39 | 1.41 |
| Melt Flow Ratio (I₁₀/I₂) | 8.58 | 8.56 | 8.84 |
| High Elution Peak (° C.) | 96.4 | 96.1 | 96.2 |
| Low Elution Peak (° C.) | 64.6 | 70.1 | 75 |
| CDBI₅₀ | 34.6 | 65.7 | 71 |
| Co/Ho | 3.7 | 5.6 | 7.1 |
| HD Fraction - | 21.3 | 15.3 | 12.4 |
| Approx. wt % | | | |
| Primary Melting | 121.2 | 102.3 | 105 |
| Peak (° C.) | | | |
| Secondary Melting | 0 | 119.7 | 118.3 |
| Peak (° C.) | | | |
| Heat of Fusion (J/g) | 132.2 | 131.6 | 131.1 |
| Crystallinity (%) | 45.6 | 45.4 | 45.2 |
| Branch Freq/1000 C | 14.3 | 14.1 | 14 |
| Comonomer ID | 1-octene | 1-octene | 1-octene |
| Comonomer | 2.9 | 2.8 | 2.8 |
| Content (mole %) | | | |
| Comonomer | 10.5 | 10.4 | 10.3 |
| Content (wt %) | | | |
| Internal Unsat/100 C | 0.006 | 0.006 | 0.007 |
| Side Chain Unsat/100 C | 0.005 | 0.005 | 0.006 |
| Terminal Unsat/100 C | 0.035 | 0.036 | 0.036 |
| Mₙ | 32069 | 38333 | 32772 |
| M_{w} | 96571 | 99429 | 95553 |
| M_{z} | 210513 | 192624 | 197540 |
| Polydispersity | 3.01 | 2.90 | 2.92 |
| Index (M_{w}/Mₙ) | | | |
| Mean Melt | 4.66 | 4.88 | 4.72 |
| Strength - 190° C. (cN) | | | |
| Mean Stretch | 591.6 | 587.2 | 594.8 |
| Ratio - 190° C. (%) | | | |
| VICAT Soft. Pt. | 104.4 | 105 | 105.1 |
| (° C.) - Plaque | | | |
| Blown Film | | | |
| Haze (percent) | 9.7 | 9.1 | 8.4 |
| gloss at 45° (gloss units) | 55 | 57 | 59 |

As the data in Tables 1A and 2A shows, as the 1-octene ratio split is decreased (e.g. as the amount of alpha-olefin comonomer being fed to the second, downstream reactor is increased relative to the amount of comonomer being fed to the first upstream reactor), the haze of a 1 mil blown film made from an ethylene copolymer composition decreases, and the gloss at 450 of a 1 mil blown film made from an ethylene copolymer composition increases.

A person skilled in the art will recognize from the data in Table 1A, that other process variables, such as the overall alpha-olefin to ethylene ratio, the ethylene concentration in each reactor or ethylene split between reactors, the hydrogen concentration in each reactor, the ethylene conversion in each reactor, and the temperature in each reactor may all be manipulated in addition to the 1-octene ratio split in order to optimize polymerization production rate and/or to maintain targeted ethylene copolymer composition properties (such as for example the ethylene copolymer composition molecular weight distribution, Mw/Mn, the weight average molecular weight, Mw, the density, the melt index, I₂, and the like).

FIG. 1 shows that there is a correlation between a TREF profile obtained for an ethylene copolymer composition and the optical properties for a 1 mil blown film made from the ethylene copolymer composition. As shown by FIG. 1, decreasing the 1-octene ratio split (by for example, increasing the relative amount of 1-octene being fed to the second reactor in which a multi-site catalyst is present), causes the “low elution temperature peak” to move to higher temperature and also the CDBI₅₀ value to increase. Without wishing to be bound by theory, the movement of the “low elution temperature peak” to a higher temperature may indicate a superior overlap of the densities of the first and second ethylene copolymers made in the first and second reactors respectively, which may in turn lead to the improvement in optical properties observed for blown film made from the ethylene copolymer composition.

TABLE 1B
Reactor Operating Conditions (Targeting an Ethylene
Copolymer Composition Having a Density of 0.918 g/cm³ and
a Melt Index, I₂ of 0.8 g/10 min)

| | Example No. | | |
|---|---|---|---|
| | 4 | 5 | 6 |
| Total Solution Rate (TSR) (kg/h) | 549.5 | 550.0 | 550.0 |
| Ethylene Concentration (wt % overall) | 15.5 | 15.3 | 15.1 |
| Ethylene Split Between Reactors | 45.0 | 45.0 | 45.0 |
| (R1/(R1 + R2) | | | |
| 1-octene/ethylene (wt %) (total) | 0.378 | 0.410 | 0.367 |
| 1-Octene Split Between Reactors | 0.50 | 0.54 | 0.60 |
| (R1/(R1 + R2)) | | | |
| 1-Octene Ratio Split Between | 0.55 | 0.59 | 0.65 |
| Reactors (R1/(R1 + R2)) | | | |
| Polymer Production Rate in kg/h | 83.5 | 85.8 | 84.3 |
| (by near infra-red) | | | |
| Reactor 1 (R1) | | | |
| Total Solution Rate in R1 (kg/h) | 288.0 | 289.1 | 285.3 |
| Ethylene Concentration (wt %) in R1 | 13.32 | 13.10 | 13.10 |
| 1-Octene/ethylene in Fresh Feed (g/g) | 0.46 | 0.54 | 0.53 |
| Primary Feed Inlet Temperature | 25.0 | 25.0 | 25.0 |
| in R1 (° C.) | | | |
| R1 Control Temperature (° C.) | 169.0 | 167.6 | 167.4 |
| Ethylene Conversion, | 78 | 78 | 78 |
| by near infra-red, in R1 (%) | | | |
| Hydrogen Feed (ppm) | 3.59 | 3.50 | 3.50 |
| Single Site Catalyst (ppm) to R1 | 0.46 | 0.51 | 0.45 |
| SSC - Al/Ti (mol/mol) | 30.1 | 60.1 | 60.1 |
| SSC - BHEB/Al (mol/mol) | 0.54 | 0.20 | 0.20 |
| SSC - B/Ti (mol/mol) | 1.20 | 1.20 | 1.20 |
| R1 Diluent Temperature (° C.) | 21.3 | 23.6 | 25.2 |
| Reactor 2 (R2) | | | |
| Total Solution Rate in R2 (kg/h) | 261.5 | 260.9 | 264.7 |
| Ethylene Fresh Feed to | 17.9 | 17.7 | 17.2 |
| R2 Concentration (wt %) | | | |
| 1-Octene/ethylene in fresh feed (g/g) | 0.37 | 0.37 | 0.29 |
| Primary Feed Temperature in R2 (° C.) | 24.9 | 30.4 | 30.1 |
| R2 Control Temperature (° C.) | 207.0 | 205.0 | 205.0 |
| Ethylene Conversion, | 83 | 78 | 80 |
| by near infra-red, in R2 (%) | | | |
| Hydrogen Feed (ppm) | 4.10 | 3.12 | 5.50 |
| Multi-Site Catalyst (Titanium | 5.69 | 6.18 | 5.09 |
| tetrachloride, TiCl₄ in ppm) to R2 | | | |
| ZN - tert-tert-Butyl chloride/ | 1.50 | 2.02 | 2.00 |
| Butyl(ethyl)magnesium in R2 (mol/mol) | | | |
| ZN - Diethylaluminium ethoxide/TiCl₄ | 1.35 | 1.35 | 1.35 |
| in R2 (mol/mol) | | | |
| ZN - Triethylaluminium/TiCl₄ | 0.37 | 0.37 | 0.37 |
| in R2 (mol/mol) | | | |
| ZN - Butyl(ethyl)magnesium/TiCl₄ | 7.2 | 7.0 | 7.0 |
| in R2 (mol/mol) | | | |
| R2 Diluent Temperature (° C.) | 29.9 | 29.9 | 30.0 |

TABLE 2B
Polymer Properties and Blown Film Optical Properties

| | Example No. | | |
|---|---|---|---|
| | 4 | 5 | 6 |
| Density (g/cm³) | 0.9177 | 0.9178 | 0.917 |
| Melt Index I₂ (g/10 min) | 0.81 | 0.81 | 0.82 |
| Melt Index I₆ (g/10 min) | 3.63 | 3.57 | 3.52 |
| Melt Index I₁₀ (g/10 min) | 6.93 | 7.33 | 6.86 |
| Melt Index I₂₁ (g/10 min) | 24.5 | 23.9 | 22.9 |
| Melt Flow Ratio (I₂₁/I₂) | 30.8 | 30.2 | 29.4 |
| Stress Exponent | 1.38 | 1.37 | 1.37 |
| Melt Flow Ratio (I₁₀/I₂) | 8.6 | 9.10 | 8.41 |
| High Elution Peak (° C.) | 95.7 | 95.9 | 95.7 |
| Low Elution Peak (° C.) | 61.9 | 60 | 60.4 |
| CDBI₅₀ | 32.1 | 24.6 | 23 |
| Co/Ho | 4.3 | 3.8 | 3.9 |
| HD Fraction - | 18.9 | 21 | 20.3 |
| Approx. wt % | | | |
| Primary Melting | 121.6 | 122.2 | 121.7 |
| Peak (° C.) | | | |
| Secondary Melting | | 0 | 0 |
| Peak (° C.) | | | |
| Heat of Fusion (J/g) | 123.8 | 121.7 | 122.3 |
| Crystallinity (%) | 42.7 | 42 | 42.2 |
| Branch Freq/1000 C | 14.7 | 15.3 | 15.3 |
| Comonomer ID | 1-octene | 1-octene | 1-octene |
| Comonomer | 2.9 | 3.1 | 3.1 |
| Content (mole %) | | | |
| Comonomer | 10.8 | 11.2 | 11.2 |
| Content (wt %) | | | |
| Internal Unsat/100 C | 0.006 | 0.006 | 0.006 |
| Side Chain Unsat/100 C | 0.01 | 0.005 | 0.007 |
| Terminal Unsat/100 C | 0.034 | 0.035 | 0.033 |
| Mₙ | 38009 | 41507 | 35328 |
| M_{w} | 100078 | 103491 | 99817 |
| M_{z} | 196285 | 198425 | 199771 |
| Polydispersity | 2.63 | 2.49 | 2.83 |
| Index (M_{w}/Mₙ) | | | |
| Mean Melt | 5.04 | 4.7 | 4.94 |
| Strength - 190° C. (cN) | | | |
| Mean Stretch | 575.4 | 542.3 | 541.5 |
| Ratio - 190° C. (%) | | | |
| VICAT Soft. Pt. | 103.8 | 102.8 | 101.7 |
| (° C.) - Plaque | | | |
| Blown Film | | | |
| Haze (percent) | 8.37 | 9.5 | 10.1 |
| gloss at 45° (gloss units) | 57 | 55.7 | 52.4 |

As the data in Tables 1B and 2B shows, as the 1-octene ratio split is decreased (e.g. as the amount of alpha-olefin comonomer being fed to the second, downstream reactor is increased relative to the amount of comonomer being fed to the first upstream reactor), the haze of a 1 mil blown film made from an ethylene copolymer composition decreases, and the gloss at 450 of a 1 mil blown film made from an ethylene copolymer composition increases.

A person skilled in the art will recognize from the data in Table 1B, that other process variables, such as the overall alpha-olefin to ethylene ratio, the ethylene concentration in each reactor or ethylene split between reactors, the hydrogen concentration in each reactor, the ethylene conversion in each reactor, and the temperature in each reactor may all be manipulated in addition to the 1-octene ratio split in order to optimize polymerization production rate and/or to maintain targeted ethylene copolymer composition properties (such as for example the ethylene copolymer composition molecular weight distribution, Mw/Mn, the weight average molecular weight, Mw, the density, the melt index, I₂, and the like).

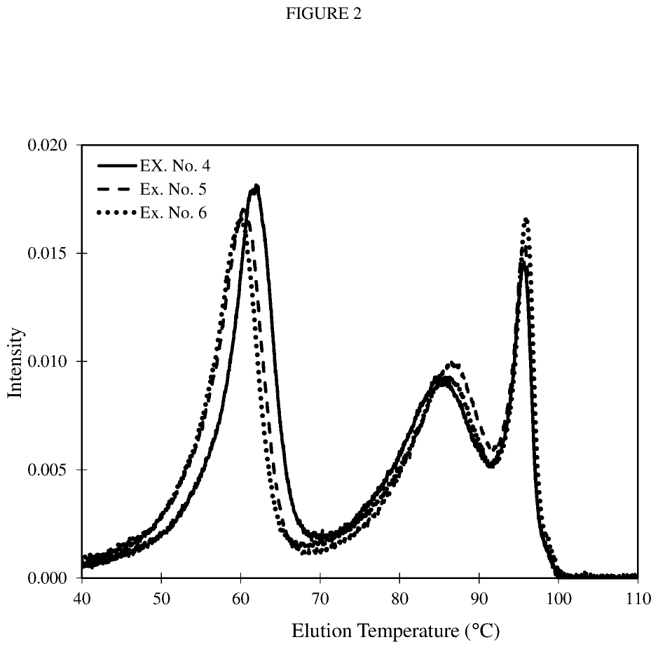

FIG. 2 shows that there is a correlation between a TREF profile obtained for an ethylene copolymer composition and the optical properties for a 1 mil blown film made from the ethylene copolymer composition. As shown by FIG. 2, decreasing the 1-octene ratio split (by, for example, increasing the relative amount of 1-octene being fed to the second reactor in which a multi-site catalyst is present), causes the “low elution temperature peak” to move to higher temperature and the CDBI₅₀ value to increase. Without wishing to be bound by theory, the movement of the “low elution temperature peak” to a higher temperature may indicate a superior overlap of the densities of the first and second ethylene copolymers made in the first and second reactors respectively, which may in turn lead to the improvement in optical properties observed for blown film made from the ethylene copolymer composition.

TABLE 1C
Reactor Operating Conditions (Targeting an Ethylene
Copolymer Composition Having a Density of 0.914 g/cm³ and
a Melt Index, I₂ of 0.9 g/10 min)

| | Example No. | | |
|---|---|---|---|
| | 7 | 8 | 9 |
| Total Solution Rate (TSR) (kg/h) | 550.0 | 549.8 | 550.0 |
| Ethylene Concentration (wt % overall) | 14.6 | 14.5 | 14.3 |
| Ethylene Split Between Reactors | 45.0 | 45.0 | 45.0 |
| (R1/(R1 + R2) | | | |
| 1-octene/ethylene (wt %) (total) | 0.595 | 0.700 | 0.874 |
| 1-Octene Split Between Reactors | 0.28 | 0.21 | 0.18 |
| (R1/(R1 + R2)) | | | |
| 1-Octene Ratio Split Between | 0.32 | 0.24 | 0.21 |
| Reactors (R1/(R1 + R2)) | | | |
| Polymer Production Rate in kg/h | 83.3 | 85.9 | 87.0 |
| (by near infra-red) | | | |
| Reactor 1 (R1) | | | |
| Total Solution Rate in R1 (kg/h) | 283.1 | 283.6 | 268.1 |
| Ethylene Concentration (wt %) in R1 | 12.76 | 12.61 | 13.20 |
| 1-Octene/ethylene in Fresh Feed (g/g) | 0.40 | 0.35 | 0.38 |
| Primary Feed Inlet Temperature | 25.0 | 25.0 | 25.0 |
| in R1 (° C.) | | | |
| R1 Control Temperature (° C.) | 166.3 | 166.1 | 169.0 |
| Ethylene Conversion, | 80 | 82 | 80 |
| by near infra-red, in R1 (%) | | | |
| Hydrogen Feed (ppm) | 3.50 | 3.50 | 4.06 |
| Single Site Catalyst (ppm) to R1 | 0.50 | 0.74 | 0.38 |
| SSC - Al/Ti (mol/mol) | 30.1 | 30.0 | 30.2 |
| SSC - BHEB/Al (mol/mol) | 0.40 | 0.35 | 0.24 |
| SSC - B/Ti (mol/mol) | 1.20 | 1.20 | 1.21 |
| R1 Diluent Temperature (° C.) | 21.2 | 19.7 | 23.0 |
| Reactor 2 (R2) | | | |
| Total Solution Rate in R2 (kg/h) | 266.9 | 266.2 | 281.9 |
| Ethylene Fresh Feed to | 16.5 | 16.4 | 15.4 |
| R2 Concentration (wt %) | | | |
| 1-Octene/ethylene in Fresh Feed (g/g) | 0.85 | 1.10 | 1.42 |
| Primary Feed Temperature in R2 (° C.) | 25.0 | 24.8 | 25.1 |
| R2 Control Temperature (° C.) | 200.0 | 199.9 | 196.2 |
| Ethylene conversion, | 83 | 85 | 83 |
| by near infra-red, in R2 (%) | | | |
| Hydrogen Feed (ppm) | 7.57 | 6.00 | 2.00 |
| Multi-Site Catalyst (Titanium | 6.16 | 7.79 | 2.64 |
| tetrachloride, TiCl₄ in ppm) to R2 | | | |
| ZN - tert-tert-Butyl chloride/ | 1.98 | 1.92 | 1.98 |
| Butyl(ethyl)magnesium in R2 (mol/mol) | | | |
| ZN - Diethylaluminium ethoxide/TiCl₄ | 1.35 | 1.35 | 1.35 |
| in R2 (mol/mol) | | | |
| ZN - Triethylaluminium/TiCl₄ | 0.37 | 0.35 | 0.37 |
| in R2 (mol/mol) | | | |
| ZN - Butyl(ethyl)magnesium/TiCl₄ | 7.2 | 6.7 | 7.1 |
| in R2 (mol/mol) | | | |
| R2 Diluent Temperature (° C.) | 30.0 | 29.8 | 30.1 |

TABLE 2C
Polymer Properties and Blown Film Optical Properties

| | Example No. | | |
|---|---|---|---|
| | 7 | 8 | 9 |
| Density (g/cm³) | 0.9142 | 0.9141 | 0.9139 |
| Melt Index I₂ (g/10 min) | 0.91 | 0.9 | 0.89 |
| Melt Index I₆ (g/10 min) | 4.08 | 4.13 | 3.96 |
| Melt Index I₁₀ (g/10 min) | 7.88 | 8.1 | 7.51 |
| Melt Index I₂₁ (g/10 min) | 27.9 | 28.7 | 27.5 |
| Melt Flow Ratio (I₂₁/I₂) | 31.7 | 33.2 | 32.2 |
| Stress Exponent | 1.4 | 1.42 | 1.4 |
| Melt Flow Ratio (I₁₀/I₂) | 8.7 | 9.04 | 8.73 |
| High Elution Peak (° C.) | 96.2 | 96 | 95.7 |
| Low Elution Peak (° C.) | 66.2 | 71 | 67.6 |
| CDBI₅₀ | 67.6 | 70.4 | 69.2 |
| Co/Ho | 7 | 8.2 | 8.6 |
| HD Fraction - | 12.6 | 10.9 | 1.5 |
| Approx. wt % | | | |
| Primary Melting | 98.5 | 100.7 | 99.67 |
| Peak (° C.) | | | |
| Secondary Melting | 118.8 | 117.7 | 117.77 |
| Peak (° C.) | | | |
| Heat of Fusion (J/g) | 117.5 | 117.3 | 118.78 |
| Crystallinity (%) | 40.5 | 40.5 | 40.962 |
| Branch Freq/1000 C | 16.7 | 16.9 | 17.4 |
| Comonomer ID | 1-octene | 1-octene | 1-octene |
| Comonomer | 3.3 | 3.4 | 3.5 |
| Content (mole %) | | | |
| Comonomer | 12.2 | 12.3 | 12.6 |
| Content (wt %) | | | |
| Internal Unsat/100 C | 0.007 | 0.007 | 0.008 |
| Side Chain Unsat/100 C | 0.007 | 0.006 | 0.006 |
| Terminal Unsat/100 C | 0.031 | 0.03 | 0.035 |
| Mₙ | 33350 | 35091 | 35659 |
| M_{w} | 93414 | 95662 | 93480 |
| M_{z} | 181573 | 194039 | 185892 |
| Polydispersity | 2.8 | 2.73 | 2.62 |
| Index (M_{w}/Mₙ) | | | |
| Mean Melt | 4.8 | 4.77 | 4.48 |
| Strength - 190° C. (cN) | | | |
| Mean Stretch | 588.3 | 538.7 | 606.2 |
| Ratio - 190° C. (%) | | | |
| VICAT Soft. Pt. | 98.8 | 99.2 | 99.3 |
| (° C.) - Plaque | | | |
| Blown Film | | | |
| Haze (percent) | 7.15 | 6.87 | 6.1 |
| gloss at 45° (gloss units) | 62 | 64 | 67 |

As the data in Tables 1C and 2C shows, as the 1-octene ratio split is decreased (e.g. as the amount of alpha-olefin comonomer being fed to the second, downstream reactor is increased relative to the amount of comonomer being fed to the first upstream reactor), the haze of a 1 mil blown film made from an ethylene copolymer composition decreases, and the gloss at 450 of a 1 mil blown film made from an ethylene copolymer composition increases.

A person skilled in the art will recognize from the data in Table 1C, that other process variables, such as the overall alpha-olefin to ethylene ratio, the ethylene concentration in each reactor or ethylene split between reactors, the hydrogen concentration in each reactor, the ethylene conversion in each reactor, and the temperature in each reactor may all be manipulated in addition to the 1-octene ratio split in order to optimize polymerization production rate and/or to maintain targeted ethylene copolymer composition properties (such as for example the ethylene copolymer composition molecular weight distribution, Mw/Mn, the weight average molecular weight, Mw, the density, the melt index, I₂, and the like).

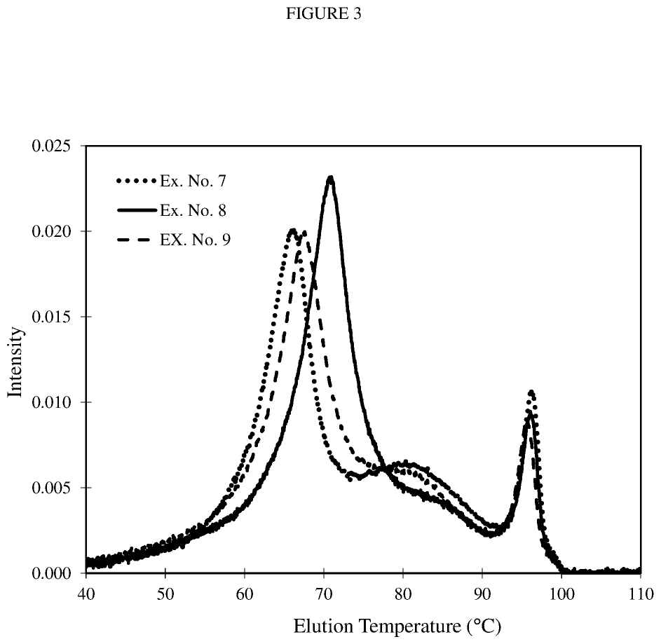

FIG. 3 shows that there is a correlation between a TREF profile obtained for an ethylene copolymer composition and the optical properties for a 1 mil blown film made from the ethylene copolymer composition. As shown by FIG. 3, decreasing the 1-octene ratio split (by, for example, increasing the relative amount of 1-octene being fed to the second reactor in which a multi-site catalyst is present), causes the “low elution temperature peak” to move to higher temperature. Without wishing to be bound by theory, the movement of the “low elution temperature peak” to a higher temperature may indicate a superior overlap of the densities of the first and second ethylene copolymers made in the first and second reactors respectively, which may in turn lead to the improvement in optical properties observed for blown film made from the ethylene copolymer composition.

TABLE 1D
Reactor Operating Conditions (Targeting an Ethylene Copolymer Composition Having
a Density of 0.912-0.913 g/cm³ and a Melt Index, I₂ of 0.8-1.0 g/10 min)

| Example No. | 10 | 11 | 12 | 13 | 14 | 15 |
|---|---|---|---|---|---|---|
| Total Solution Rate (TSR) (kg/h) | 549.9 | 550.0 | 550.0 | 500.0 | 550.0 | 550.0 |
| Ethylene Concentration (wt % overall) | 12.6 | 12.6 | 13.7 | 13.6 | 15.0 | 14.5 |
| Ethylene Split Between Reactors | 45.0 | 45.0 | 45.0 | 45.0 | 45.0 | 45.0 |
| (R1/(R1 + R2) | | | | | | |
| 1-octene/ethylene | 0.78 | 0.67 | 0.684 | 0.685 | 0.640 | 0.563 |
| (wt %) (total) | | | | | | |
| 1-Octene Split Between Reactors | 0.17 | 0.24 | 0.25 | 0.29 | 0.35 | 0.40 |
| (R1/(R1 + R2)) | | | | | | |
| 1-Octene Ratio Split Between Reactors | 0.20 | 0.28 | 0.29 | 0.33 | 0.40 | 0.45 |
| (R1/(R1 + R2)) | | | | | | |
| Polymer Production Rate in kg/h | 61.3 | 61.3 | 79.6 | 73.6 | 89.9 | 82.9 |
| (by near infra-red) | | | | | | |
| Reactor 1 (R1) | | | | | | |
| Total Solution Rate in R1 (kg/h) | 331.7 | 331.8 | 265.0 | 241.6 | 299.4 | 289.4 |
| Ethylene concentration (wt %) in R1 | 9.40 | 9.40 | 12.77 | 12.70 | 12.40 | 12.40 |
| 1-Octene/ethylene in Fresh Feed (g/g) | 0.32 | 0.39 | 0.41 | 0.47 | 0.54 | 0.54 |
| Primary Feed Inlet Temperature | 30.0 | 30.0 | 25.0 | 25.0 | 25.0 | 25.0 |
| in R1 (° C.) | | | | | | |
| R1 Control Temperature (° C.) | 136.1 | 135.9 | 165.5 | 164.5 | 163.8 | 164.1 |
| Ethylene Conversion, by | 80 | 80 | 80 | 80 | 80 | 80 |
| near infra-red, in R1 (%) | | | | | | |
| Hydrogen Feed (ppm) | 6.30 | 6.30 | 4.00 | 3.15 | 3.25 | 3.25 |
| Single Site Catalyst (ppm) to R1 | 0.32 | 0.32 | 0.41 | 0.43 | 0.53 | 0.55 |
| SSC - Al/Ti (mol/mol) | 30.1 | 30.1 | 30.1 | 30.1 | 60.0 | 60.1 |
| SSC - BHEB/Al (mol/mol) | 0.56 | 0.42 | 0.20 | 0.40 | 0.20 | 0.20 |
| SSC - B/Ti (mol/mol) | 1.20 | 1.20 | 1.20 | 1.21 | 1.20 | 1.20 |
| R1 Diluent Temperature (° C.) | 38.2 | 32.3 | 22.9 | 28.2 | 24.1 | 25.4 |
| Reactor 2 (R2) | | | | | | |
| Total Solution Rate in R2 (kg/h) | 218.2 | 218.2 | 285.0 | 258.4 | 250.6 | 260.6 |
| Ethylene fresh feed to R2 Concentration | 17.5 | 17.5 | 14.5 | 14.6 | 18.1 | 16.8 |
| (wt %) | | | | | | |
| 1-Octene/ethylene in Fresh Feed (g/g) | 1.29 | 1.01 | 1.02 | 0.97 | 0.82 | 0.67 |
| Primary Feed Temperature in R2 (° C.) | 40.1 | 40.0 | 24.9 | 40.0 | 29.8 | 30.2 |
| R2 Control Temperature (° C.) | 182.2 | 181.9 | 189.7 | 194.8 | 200.0 | 200.1 |
| Ethylene Conversion, by | 82 | 82 | 83 | 83 | 79 | 80 |
| near infra-red, in R2 (%) | | | | | | |
| Hydrogen Feed (ppm) | 0.49 | 0.49 | 1.03 | 1.00 | 2.33 | 4.50 |
| Multi-Site Catalyst (Titanium | 3.26 | 2.78 | 2.87 | 4.45 | 4.68 | 6.25 |
| tetrachloride, TiCl₄ in ppm) to R2 | | | | | | |
| ZN - tert-tert-Butyl chloride/ | 1.52 | 1.52 | 1.98 | 1.98 | 2.02 | 2.03 |
| Butyl(ethyl)magnesium in R2 (mol/mol) | | | | | | |
| ZN - Diethylaluminium ethoxide/TiCl₄ | 1.35 | 1.35 | 1.34 | 1.35 | 1.35 | 1.35 |
| in R2 (mol/mol) | | | | | | |
| ZN - Triethylaluminium/TiCl₄ | 0.35 | 0.35 | 0.37 | 0.37 | 0.37 | 0.37 |
| in R2 (mol/mol) | | | | | | |
| ZN - Butyl(ethyl)magnesium/TiCl₄ | 7.1 | 7.3 | 7.2 | 7.2 | 7.0 | 6.5 |
| in R2 (mol/mol) | | | | | | |
| R2 Diluent Temperature (° C.) | 40.0 | 35.2 | 29.9 | 31.8 | 29.9 | 30.2 |

TABLE 2D
Polymer Properties and Blown Film Optical Properties

| Example No. | 10 | 11 | 12 | 13 | 14 | 15 |
|---|---|---|---|---|---|---|
| Density (g/cm³) | 0.9128 | 0.9123 | 0.9129 | 0.9119 | 0.9125 | 0.9123 |
| Melt Index I₂ (g/10 min) | 0.84 | 0.76 | 0.87 | 0.86 | 1 | 0.82 |
| Melt Index I₆ (g/10 min) | 3.33 | 3.2 | 3.98 | 4 | 4.34 | 3.65 |
| Melt Index I₁₀ (g/10 min) | 6 | 5.72 | 7.62 | 7.67 | 8.7 | 7.02 |
| Melt Index I₂₁ (g/10 min) | 19.9 | 18.7 | 27.4 | 27.9 | 30.1 | 24.2 |
| Melt Flow Ratio (I₂₁/I₂) | 23.6 | 23.7 | 31.6 | 32.6 | 31.5 | 29.8 |
| Stress Exponent | 1.25 | 1.27 | 1.39 | 1.4 | 1.38 | 1.37 |
| Melt Flow Ratio (I₁₀/I₂) | 7.18 | 7.52 | 8.76 | 8.92 | 8.70 | 8.56 |
| High Elution Peak (° C.) | 95.8 | 95.8 | 95.6 | 95.7 | 96 | 95.9 |
| Low Elution Peak (° C.) | 67.9 | 62.3 | 64.6 | 61.1 | 57.2 | 57.9 |
| CDBI₅₀ | 69.6 | 64.8 | 69.1 | 64.7 | 52.8 | 54.9 |
| Co/Ho | 8.5 | 7.5 | 9.1 | 8.5 | 5.9 | 6.1 |
| HD Fraction - Approx. wt % | 10.6 | 11.8 | 10 | 10.6 | 14.6 | 14.1 |
| Primary Melting Peak (° C.) | 99 | 95.8 | 98 | 95.4 | 95.2 | 95.6 |
| Secondary Melting Peak (° C.) | 117.5 | 118.4 | 117.62 | 118.2 | 110.5 | 111.3 |
| Heat of Fusion (J/g) | 113.9 | 114.1 | 105.85 | 112.1 | 110.1 | 112.2 |
| Crystallinity (%) | 39.3 | 39.4 | 36.496 | 38.7 | 38 | 38.7 |
| Branch Freq/1000 C | 17.9 | 18.5 | 18.3 | 19.5 | 18.7 | 18.2 |
| Comonomer ID | 1-octene | 1-octene | 1-octene | 1-octene | 1-octene | 1-octene |
| Comonomer Content (mole %) | 3.6 | 3.7 | 3.7 | 3.9 | 3.7 | 3.6 |
| Comonomer Content (wt %) | 12.9 | 13.3 | 13.2 | 14 | 13.4 | 13.1 |
| Internal Unsat/100 C | 0.005 | 0.005 | 0.007 | 0.007 | 0.007 | 0.007 |
| Side Chain Unsat/100 C | 0 | 0 | 0.005 | 0.008 | 0.007 | 0.006 |
| Terminal Unsat/100 C | 0.026 | 0.027 | 0.033 | 0.034 | 0.035 | 0.029 |
| Mₙ | 37552 | 41197 | 39653 | 29257 | 34200 | 33639 |
| M_{w} | 108775 | 115423 | 94298 | 91907 | 99038 | 95999 |
| M_{z} | 229055 | 283932 | 181841 | 218901 | 202274 | 188064 |
| Polydispersity Index (M_{w}/Mₙ) | 2.9 | 2.8 | 2.38 | 3.14 | 2.9 | 2.85 |
| Mean Melt Strength - 190° C. (cN) | 3.98 | 4.27 | 4.64 | 4.61 | 4.13 | 4.99 |
| Mean Stretch Ratio - 190° C. (%) | 607.8 | 741.6 | 518.2 | 518.2 | 544.1 | 535.4 |
| VICAT Soft. Pt. (° C.) - Plaque | 99.1 | 97.7 | 97.3 | 96.1 | 95 | 96.2 |
| Blown Film | | | | | | |
| Haze (percent) | 3.5 | 4.5 | 5.1 | 6.6 | 7.9 | 8.1 |
| gloss at 45° (gloss units) | 78 | 73 | 65 | 62 | 58.3 | 58.7 |

As the data in Tables 1D and 2D shows, as the 1-octene ratio split is decreased (e.g. as the amount of alpha-olefin comonomer being fed to the second, downstream reactor is increased relative to the amount of comonomer being fed to the first upstream reactor), the haze of a 1 mil blown film made from an ethylene copolymer composition decreases, and the gloss at 450 of a 1 mil blown film made from an ethylene copolymer composition increases.

A person skilled in the art will recognize from the data in Table 1D, that other process variables, such as the overall alpha-olefin to ethylene ratio, the ethylene concentration in each reactor or ethylene split between reactors, the hydrogen concentration in each reactor, the ethylene conversion in each reactor, and the temperature in each reactor may all be manipulated in addition to the 1-octene ratio split in order to optimize polymerization production rate and/or to maintain targeted ethylene copolymer composition properties (such as for example the ethylene copolymer composition molecular weight distribution, Mw/Mn, the weight average molecular weight, Mw, the density, the melt index, I₂, and the like).

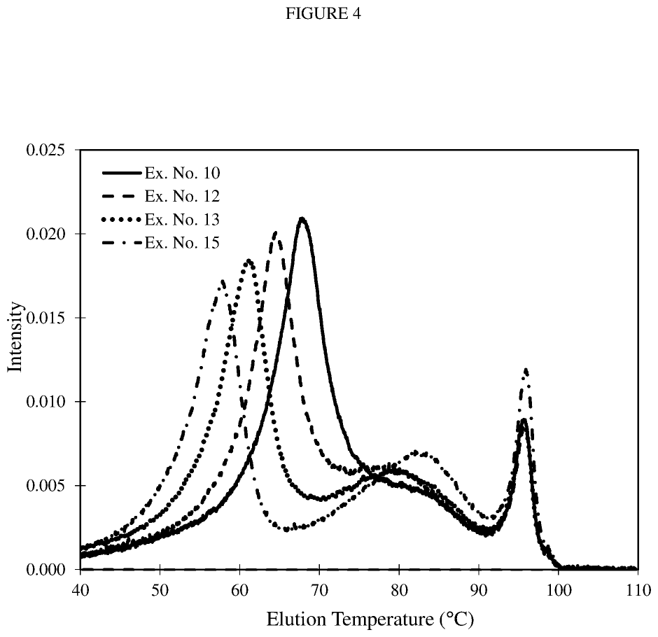

FIG. 4 shows that there is a correlation between a TREF profile obtained for an ethylene copolymer composition and the optical properties for a 1 mil blown film made from the ethylene copolymer composition. As shown by FIG. 4, decreasing the 1-octene ratio split (by, for example, increasing the relative amount of 1-octene being fed to the second reactor in which a multi-site catalyst is present), causes the “low elution temperature peak” to move to higher temperature. Without wishing to be bound by theory, the movement of the “low elution temperature peak” to a higher temperature may indicate a superior overlap of the densities of the first and second ethylene copolymers made in the first and second reactors respectively, which may in turn lead to the improvement in optical properties observed for blown film made from the ethylene copolymer composition.

TABLE 1E
Reactor Operating Conditions (Targeting an Ethylene
Copolymer Composition Having a Density of 0.908 g/cm³ and
a Melt Index, I₂ of 0.75-0.85 g/10 min)

| | Example No. | |
|---|---|---|
| | 16 | 17 |
| Total Solution Rate (TSR) (kg/h) | 550.0 | 550.0 |
| Ethylene Concentration (wt % overall) | 12.7 | 14.0 |
| Ethylene Split Between Reactors (R1/(R1 + R2) | 45.0 | 45.0 |
| 1-octene/ethylene (wt %) (total) | 0.845 | 0.738 |
| 1-Octene Split Between Reactors (R1/(R1 + R2)) | 0.24 | 0.31 |
| 1-Octene Ratio Split Between Reactors | 0.28 | 0.36 |
| (R1/(R1 + R2)) | | |
| Polymer Production Rate in kg/h (by near infra-red) | 77.4 | 82.9 |
| Reactor 1 (R1) | | |
| Total Solution Rate in R1 (kg/h) | 268.7 | 298.7 |
| Ethylene Concentration (wt %) in R1 | 11.70 | 11.60 |
| 1-Octene/ethylene in Fresh Feed (g/g) | 0.48 | 0.56 |
| Primary Feed Inlet Temperature in R1 (° C.) | 25.0 | 25.0 |
| R1 Control Temperature (° C.) | 156.5 | 156.2 |
| Ethylene Conversion, by near infra-red, in R1 (%) | 80 | 80 |
| Hydrogen Feed (ppm) | 3.93 | 3.45 |
| Single Site Catalyst (ppm) to R1 | 0.42 | 0.50 |
| SSC - Al/Ti (mol/mol) | 30.2 | 60.1 |
| SSC - BHEB/Al (mol/mol) | 0.21 | 0.20 |
| SSC - B/Ti (mol/mol) | 1.21 | 1.20 |
| R1 Diluent Temperature (° C.) | 27.4 | 24.5 |
| Reactor 2 (R2) | | |
| Total Solution Rate in R2 (kg/h) | 281.4 | 251.3 |
| Ethylene Fresh Feed to R2 Concentration (wt %) | 13.6 | 16.8 |
| 1-Octene/ethylene in Fresh Feed (g/g) | 1.28 | 1.01 |
| Primary Feed Temperature in R2 (° C.) | 25.0 | 29.9 |
| R2 Control Temperature (° C.) | 183.2 | 199.9 |
| Ethylene Conversion, by near infra-red, in R2 (%) | 83 | 85 |
| Hydrogen Feed (ppm) | 1.00 | 6.76 |
| Multi-Site Catalyst (Titanium tetrachloride, | 2.82 | 7.13 |
| TiCl₄ in ppm) to R2 | | |
| ZN - tert-tert-Butyl | 1.98 | 2.00 |
| chloride/Butyl(ethyl)magnesium in R2 (mol/mol) | | |
| ZN - Diethylaluminium ethoxide/TiCl₄ in R2 | 1.35 | 1.35 |
| (mol/mol) | | |
| ZN - Triethylaluminium/TiCl₄ in R2 (mol/mol) | 0.37 | 0.37 |
| ZN - Butyl(ethyl)magnesium/TiCl₄ in R2 (mol/mol) | 7.1 | 7.1 |
| R2 Diluent Temperature (° C.) | 31.3 | 29.8 |

TABLE 2E
Polymer Properties and Blown Film Optical Properties

Example No.

| | 16 | 17 |
|---|---|---|
| Density (g/cm³) | 0.9077 | 0.9078 |
| Melt Index I₂ (g/10 min) | 0.84 | 0.74 |
| Melt Index I₆ (g/10 min) | 3.89 | 3.35 |
| Melt Index I₁₀ (g/10 min) | 7.3 | 6.46 |
| Melt Index I₂₁ (g/10 min) | 28.3 | 23 |
| Melt Flow Ratio (I₂₁/I₂) | 33.9 | 31.5 |
| Stress Exponent | 1.4 | 1.39 |
| Melt Flow Ratio (I₁₀/I₂) | 8.90 | 8.73 |
| High Elution Peak (° C.) | 95.4 | 95.8 |
| Low Elution Peak (° C.) | 59.4 | 56.6 |
| CDBI₅₀ | 71.8 | 65.7 |
| Co/Ho | 12 | 9 |
| HD Fraction - Approx. wt % | 7.7 | 10 |
| Primary Melting Peak (° C.) | 92.92 | 91.5 |
| Secondary Melting Peak (° C.) | 115.91 | 118.1 |
| Heat of Fusion (J/g) | 103.87 | 104.4 |
| Crystallinity (%) | 35.818 | 36 |
| Branch Freq/1000 C | 22 | 21.1 |
| Comonomer ID | Octene | Octene |
| Comonomer Content (mole %) | 4.4 | 4.2 |
| Comonomer Content (wt %) | 15.5 | 15 |
| Internal Unsat/100 C | 0.008 | 0.007 |
| Side Chain Unsat/100 C | 0.006 | 0.007 |
| Terminal Unsat/100 C | 0.033 | 0.028 |
| Mₙ | 26133 | 24387 |
| M_{w} | 98063 | 103947 |
| M_{z} | 233450 | 246457 |
| Polydispersity Index (M_{w}/Mₙ) | 3.75 | 4.26 |
| Mean Melt Strength - 190° C. (cN) | 4.91 | 5.21 |
| Mean Stretch Ratio - 190° C. (%) | 455.1 | 491.4 |
| VICAT Soft. Pt. (° C.) - Plaque | 89.8 | 92 |
| Blown Film | | |
| Haze (percent) | 4.1 | 6.7 |
| gloss at 45° (gloss units) | 78 | 61.4 |

As the data in Tables 1E and 2E shows, as the 1-octene ratio split is decreased (e.g. as the amount of alpha-olefin comonomer being fed to the second, downstream reactor is increased relative to the amount of comonomer being fed to the first upstream reactor), the haze of a 1 mil blown film made from an ethylene copolymer composition decreases, and the gloss at 450 of a 1 mil blown film made from an ethylene copolymer composition increases.

A person skilled in the art will recognize from the data in Table 1E, that other process variables, such as the overall alpha-olefin to ethylene ratio, the ethylene concentration in each reactor or ethylene split between reactors, the hydrogen concentration in each reactor, the ethylene conversion in each reactor, and the temperature in each reactor may all be manipulated in addition to the 1-octene ratio split in order to optimize polymerization production rate and/or to maintain targeted ethylene copolymer composition properties (such as for example the ethylene copolymer composition molecular weight distribution, Mw/Mn, the weight average molecular weight, Mw, the density, the melt index, I₂, and the like).

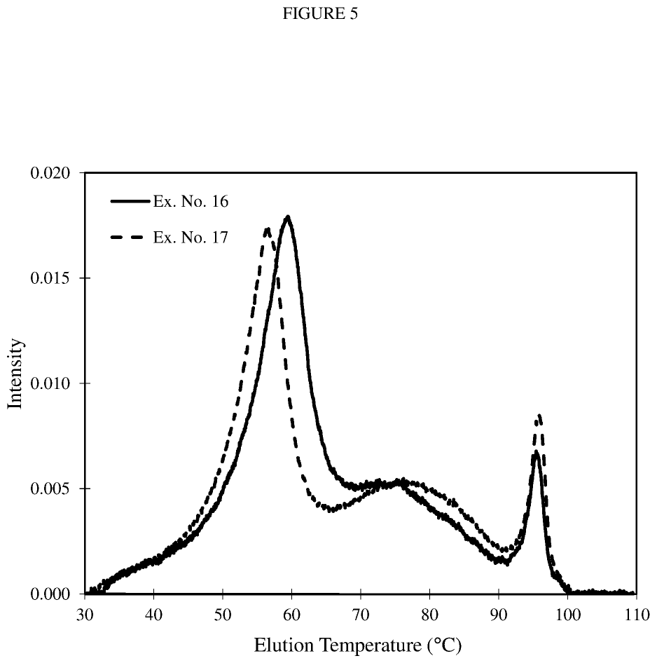

FIG. 5 shows that there is a correlation between a TREF profile obtained for an ethylene copolymer composition and the optical properties for a 1 mil blown film made from the ethylene copolymer composition. As shown by FIG. 5, decreasing the 1-octene ratio split (by, for example, increasing the relative amount of 1-octene being fed to the second reactor in which a multi-site catalyst is present), causes the “low elution temperature peak” to move to higher temperature and the CDBI₅₀ to increase. Without wishing to be bound by theory, the movement of the “low elution temperature peak” to a higher temperature may indicate a superior overlap of the densities of the first and second ethylene copolymers made in the first and second reactors respectively, which may in turn lead to the improvement in optical properties observed for blown film made from the ethylene copolymer composition.

Non-limiting embodiments of the present disclosure include the following:

Embodiment A. A method for improving the optical properties of an ethylene copolymer composition made in a solution phase polymerization process;
the solution phase polymerization process comprising:
   polymerizing ethylene and an alpha-olefin in a first reactor with a single site catalyst;
   polymerizing ethylene and an alpha-olefin in a second reactor with a multi-site catalyst;
   optionally polymerizing ethylene and an alpha-olefin in a third reactor with a single site catalyst or a multi-site catalyst;
   wherein the first, second and optional third reactor are configured in series with one another;
the method comprising:
   decreasing the alpha-olefin ratio split from a first higher value to a second lower value, wherein the alpha-olefin ratio split is defined by the equation:

$$F {1}_{α - olefin} \times F {2}_{ethylene} / ( F {1}_{α - olefin} \times F {2}_{ethylene} + F {2}_{α - olefin} \times F {1}_{ethylene} ) ;$$

where F1_{α-olefin} is the flow rate (in kg/hour) of alpha-olefin to the first reactor; F1_{ethylene} is flow rate (in kg/hour) of ethylene to the first reactor; F2_{α-olefin} is flow rate (in kg/hour) of alpha-olefin to the second reactor; and F2_{ethylene} is the flow rate (in kg/hour) of ethylene to the second reactor; and
   wherein the improvement of the optical properties of the ethylene copolymer composition is indicated by one or both of: a decrease in optical haze of a monolayer blown film which is made from the ethylene copolymer composition;
   an increase in gloss at 450 of a monolayer blown film which is made from the ethylene copolymer composition.

Embodiment B. The method of Embodiment A wherein the monolayer blown film has a thickness of 1 mil.

Embodiment C. The method of Embodiment A, or B, wherein the alpha-olefin ratio split is decreased by 5 percent.

Embodiment D. The method of Embodiment A, or B, wherein the alpha-olefin ratio split is decreased by 10 percent.

Embodiment E. The method of Embodiment A, B, C, or D, wherein the alpha-olefin is 1-octene.

Embodiment F. The method of Embodiment A, B, C, D, or E, wherein the single site catalyst is a phosphinimine catalyst.

Embodiment G. The method of Embodiment A, B, C, D, E, or F, wherein the multi-site catalyst is a Ziegler-Natta catalyst.

Embodiment H. The method of Embodiment A, B, C, D, E, F, or G, wherein the ethylene copolymer composition has a density of from 0.912 to 0.939 g/cm³.

Embodiment I. The method of Embodiment A, B, C, D, E, F, G, or H, wherein the ethylene copolymer composition has a melt index, I₂ of from 0.1 to 10 g/10 min.

Embodiment J. The method of Embodiment A, B, C, D, E, F, G, H, or I, wherein a polymerization temperature in the second reactor is higher than a polymerization temperature in the first reactor.

Embodiment K. The method of Embodiment A, B, C, D, E, F, G, H, or I, wherein a polymerization temperature in the second reactor is at least 30° C. higher than a polymerization temperature in the first reactor.

Embodiment L. A method for improving the optical properties of an ethylene copolymer composition comprising a first ethylene copolymer, a second ethylene copolymer and optionally a third ethylene copolymer, wherein the ethylene copolymer composition is made in a solution phase polymerization process;
the solution phase polymerization process comprising:
   polymerizing ethylene and an alpha-olefin in a first reactor with a single site catalyst to give a first ethylene copolymer;
   polymerizing ethylene and an alpha-olefin in a second reactor with a multi-site catalyst to give a second ethylene copolymer;
   optionally polymerizing ethylene and an alpha-olefin in a third reactor with a single site catalyst or a multi-site catalyst to give a third ethylene copolymer;
   wherein the first, second and optional third reactor are configured in series with one another;
the method comprising:
   decreasing the alpha-olefin ratio split from a first higher value to a second lower value, wherein the alpha-olefin ratio split is defined by the equation:

$$F {1}_{α - olefin} \times F {2}_{ethylene} / ( F {1}_{α - olefin} \times F {2}_{ethylene} + F {2}_{α - olefin} \times F {1}_{ethylene} ) ;$$

where F1_{α-olefin} is the flow rate (in kg/hour) of alpha-olefin to the first reactor; F1_{ethylene} is flow rate (in kg/hour) of ethylene to the first reactor; F2_{α-olefin} is flow rate (in kg/hour) of alpha-olefin to the second reactor; and F2_{ethylene} is the flow rate (in kg/hour) of ethylene to the second reactor; and
   wherein the improvement of the optical properties of the ethylene copolymer composition is indicated by one or both of:
   a decrease in optical haze of a monolayer blown film which is made from the ethylene copolymer composition;
   an increase in gloss at 450 of a monolayer blown film which is made from the ethylene copolymer composition.

Embodiment M. The method of Embodiment L wherein the monolayer blown film has a thickness of 1 mil.

Embodiment N. The method of Embodiment L, or M, wherein the alpha-olefin ratio split is decreased by 5 percent.

Embodiment O. The method of Embodiment L, or M, wherein the alpha-olefin ratio split is decreased by 10 percent.

Embodiment P. The method of Embodiment L, M, N, or O, wherein the alpha-olefin is 1-octene.

Embodiment Q. The method of Embodiment L, M, N, O, or P, wherein the single site catalyst is a phosphinimine catalyst.

Embodiment R. The method of Embodiment L, M, N, O, P, or Q, wherein the multi-site catalyst is a Ziegler-Natta catalyst.

Embodiment S. The method of Embodiment L, M, N, O, P, Q, or R, wherein the ethylene copolymer composition has a density of from 0.912 to 0.939 g/cm³.

Embodiment T. The method of Embodiment L, M, N, O, P, Q, R, or S, wherein the ethylene copolymer composition has a melt index, I₂ of from 0.1 to 10 g/10 min.

Embodiment U. The method of Embodiment L, M, N, O, P, Q, R, S, or T, wherein a polymerization temperature in the second reactor is higher than a polymerization temperature in the first reactor.

Embodiment V. The method of Embodiment L, M, N, O, P, Q, R, S, or T, wherein a polymerization temperature in the second reactor is at least 30° C. higher than a polymerization temperature in the first reactor.

### INDUSTRIAL APPLICABILITY

Provided is a method to improve the optical properties of an ethylene copolymer composition which is made in a multi reactor solution phase polymerization process. Ethylene copolymer compositions having improved optical properties when made into films are commercially desirable.

1. A method for improving the optical properties of an ethylene copolymer composition made in a solution phase polymerization process;
the solution phase polymerization process comprising:
polymerizing ethylene and an alpha-olefin in a first reactor with a single site catalyst;
polymerizing ethylene and an alpha-olefin in a second reactor with a multi-site catalyst;
optionally polymerizing ethylene and an alpha-olefin in a third reactor with a single site catalyst or a multi-site catalyst;
wherein the first, second and optional third reactor are configured in series with one another;
the method comprising:
decreasing the alpha-olefin ratio split from a first higher value to a second lower value, wherein the alpha-olefin ratio split is defined by the equation:
$$F {1}_{α - olefin} \times F {2}_{ethylene} / ( F {1}_{α - olefin} \times F {2}_{ethylene} + F {2}_{α - olefin} \times F {1}_{ethylene} ) ;$$
where F1_{α-olefin} is the flow rate (in kg/hour) of alpha-olefin to the first reactor; F1_{ethylene} is the flow rate (in kg/hour) of ethylene to the first reactor; F2_{α-olefin} is the flow rate (in kg/hour) of alpha-olefin to the second reactor; and F2_{ethylene} is the flow rate (in kg/hour) of ethylene to the second reactor; and
wherein the improvement of the optical properties of the ethylene copolymer composition is indicated by one or both of:
a decrease in optical haze of a monolayer blown film which is made from the ethylene copolymer composition;
an increase in gloss at 450 of a monolayer blown film which is made from the ethylene copolymer composition.

2. The method of claim 1, wherein the monolayer blown film has a thickness of 1 mil.

3. The method of claim 1, wherein the alpha-olefin ratio split is decreased by 5 percent.

4. The method of claim 1, wherein the alpha-olefin ratio split is decreased by 10 percent.

5. The method of claim 1, wherein the alpha-olefin is 1-octene.

6. The method of claim 1, wherein the single site catalyst is a phosphinimine catalyst.

7. The method of claim 1, wherein the multi-site catalyst is a Ziegler-Natta catalyst.

8. The method of claim 1, wherein the ethylene copolymer composition has a density of from 0.912 to 0.939 g/cm³.

9. The method of claim 1, wherein the ethylene copolymer composition has a melt index, 1₂ of from 0.1 to 10 g/10 min.

10. The method of claim 1, wherein a polymerization temperature in the second reactor is higher than a polymerization temperature in the first reactor.

11. The method of claim 1, wherein a polymerization temperature in the second reactor is at least 30° C. higher than a polymerization temperature in the first reactor.

12. A method for improving the optical properties of an ethylene copolymer composition comprising a first ethylene copolymer, a second ethylene copolymer and optionally a third ethylene copolymer, wherein the ethylene copolymer composition is made in a solution phase polymerization process;
the solution phase polymerization process comprising:
polymerizing ethylene and an alpha-olefin in a first reactor with a single site catalyst to give a first ethylene copolymer;
polymerizing ethylene and an alpha-olefin in a second reactor with a multi-site catalyst to give a second ethylene copolymer;
optionally polymerizing ethylene and an alpha-olefin in a third reactor with a single site catalyst or a multi-site catalyst to give a third ethylene copolymer;
wherein the first, second and optional third reactor are configured in series with one another;
the method comprising:
decreasing the alpha-olefin ratio split from a first higher value to a second lower value, wherein the alpha-olefin ratio split is defined by the equation:
$$F {1}_{α - olefin} \times F {2}_{ethylene} / ( F {1}_{α - olefin} \times F {2}_{ethylene} + F {2}_{α - olefin} \times F {1}_{ethylene} ) ;$$
where F1_{α-olefin} is the flow rate (in kg/hour) of alpha-olefin to the first reactor; F1_{ethylene} is the flow rate (in kg/hour) of ethylene to the first reactor; F2_{α-olefin} is the flow rate (in kg/hour) of alpha-olefin to the second reactor; and F2_{ethylene} is the flow rate (in kg/hour) of ethylene to the second reactor; and
wherein the improvement of the optical properties of the ethylene copolymer composition is indicated by one or both of:
a decrease in optical haze of a monolayer blown film which is made from the ethylene copolymer composition;
an increase in gloss at 450 of a monolayer blown film which is made from the ethylene copolymer composition.

13. The method of claim 12, wherein the monolayer blown film has a thickness of 1 mil.

14. The method of claim 12, wherein the alpha-olefin ratio split is decreased by 5 percent.

15. The method of claim 12, wherein the alpha-olefin ratio split is decreased by 10 percent.

16. The method of claim 12, wherein the alpha-olefin is 1-octene.

17. The method of claim 12, wherein the single site catalyst is a phosphinimine catalyst.

18. The method of claim 12, wherein the multi-site catalyst is a Ziegler-Natta catalyst.

19. The method of claim 12, wherein the ethylene copolymer composition has a density of from 0.912 to 0.939 g/cm³.

20. The method of claim 12, wherein the ethylene copolymer composition has a melt index, 1₂ of from 0.1 to 10 g/10 min.

21. The method of claim 12, wherein a polymerization temperature in the second reactor is higher than a polymerization temperature in the first reactor.

22. The method of claim 12, wherein a polymerization temperature in the second reactor is at least 30° C. higher than a polymerization temperature in the first reactor.
